(19) United States
(12) Patent Application Publication
(10) Pub. No.: US 2026/0075641 A1
(43) Pub. Date: Mar. 12, 2026

(54) COVERAGE ENHANCEMENT (CE) RANDOM ACCESS (RA) SIGNALING AND CONFIGURING

(71) Applicant: Telefonaktiebolaget LM Ericsson (publ), Stockholm (SE)

(72) Inventors: Jonas SEDIN, Sollentuna (SE); Ling SU, Beijing (CN); Oskar MYRBERG, Norrköping (SE)

(73) Assignee: Telefonaktiebolaget LM Ericsson (publ), Stockholm (SE)

(21) Appl. No.: 19/107,641

(22) PCT Filed: Sep. 22, 2022
(86) PCT No.: PCT/CN2022/116818

§ 371 Date: Feb. 28, 2025

(51) Int. Cl. H04W 74/00; H04W 74/0838

(52) U.S. Cl. CPC H04W 74/006; H04W 74/0838

(57) ABSTRACT

The present disclosure is related to a UE, a network node, and methods for CE RA signaling and configuring. A method at a UE for performing an RA procedure comprises: receiving, from a network node, one or more parameters; and determining, based on at least the one or more parameters, at least one of: a first number of PRACH transmissions; a second number of PUSCH transmissions scheduled by a RAR associated with the RA procedure; and a third number of MsgA PUSCH transmissions.

### TECHNICAL FIELD

The present disclosure is related to the field of telecommunication, and in particular, to a User Equipment (UE), a network node, and methods for coverage enhancement (CE) random access (RA) signaling and configuring.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a UE for performing an RA procedure is provided. The method comprises: receiving, from a network node, one or more parameters; and determining, based on at least the one or more parameters, at least one of: a first number of PRACH transmissions; a second number of PUSCH transmissions scheduled by a Random Access Response (RAR) associated with the RA procedure; and a third number of MsgA PUSCH transmissions.

In some embodiments, the method further comprises at least one of: performing the first number of PRACH transmissions; performing the second number of PUSCH transmissions scheduled by the RAR; and performing the third number of MsgA PUSCH transmissions. In some embodiments, the one or more parameters comprise at least one of: one or more first candidate numbers of PRACH transmissions; one or more second candidate numbers of PUSCH transmissions scheduled by the RAR associated with the RA procedure; one or more third candidate numbers of MsgA PUSCH transmissions; a preamble index; and an identifier indicating a resource within a Random Access Channel (RACH) indication and partitioning configuration framework.

In some embodiments, when the one or more parameters comprise a single first candidate number, the step of determining the first number comprises: determining the single first candidate number as the first number. In some embodiments, when the one or more parameters comprise multiple first candidate numbers, the step of determining the first number comprises: determining one of the multiple first candidate numbers as the first number based on at least Reference Signal Received Power (RSRP) measured for a selected Synchronous Signal and PBCH block (SSB). In some embodiments, the one or more parameters further comprise at least one of: one or more offsets to a first threshold, the first threshold being used in determining whether the RA procedure without CE is to fall back from a contention free random access (CFRA) procedure to a contention based random access (CBRA) procedure; one or more second thresholds, each of which is used in determining whether the CFRA procedure is to fall back, at a corresponding CE level, from a CFRA procedure to a CBRA procedure; and a flag indicating that no fallback from a CFRA procedure to a CBRA procedure is allowed.

In some embodiments, when the one or more parameters comprise the one or more offsets, multiple ranges are defined by the one or more offsets and the first threshold and at least one of the multiple ranges, Rᵢ, is defined as follows:

$${R}_{i} = \{ \begin{matrix}( the first threshold , + ∞ ) , & if i = 1 \\ ( the first threshold - & if i = 2 \\ {\sum }_{k = 1}^{i - 1} {offset}_{k} , the first threshold ] , & \\ ( the first threshold - {\sum }_{k = 1}^{i - 1} {offset}_{k} , & if 2 < i \leq N + 1 \\ the first threshold - {\sum }_{k = 1}^{i - 2} {offset}_{k} ] , & \end{matrix}$$

where offsetₖ is the k^{th} offset, and N is the number of the one or more offsets.

In some embodiments, when the one or more parameters comprise the one or more second thresholds, multiple ranges are defined by the one or more second thresholds and the first threshold and at least one of the multiple ranges R; is defined as follows:

$${R}_{i} = \{ \begin{matrix}( the first threshold , + ∞ ) , & if i = 1 \\ ( the {( i - 1 )}^{th} second threshold , & if i = 2 \\ the first threshold ] , & \\ ( the {( i - 1 )}^{th} second threshold , & if 2 < i \leq N + 1 \\ the {( i - 2 )}^{th} second threshold ] , & \end{matrix}$$

where N is the number of the one or more second thresholds.

In some embodiments, the step of determining the first number comprises: determining one of the multiple ranges into which the RSRP measured for the selected SSB falls; and determining one of the multiple first candidate numbers associated with the determined range as the first number. In some embodiments, the first number is determined to be 1 when the index of the determined range is 1. In some embodiments, the first number is determined to be greater when the index of the determined range is greater.

In some embodiments, when the RA procedure is a Type 2 RA procedure, the step of determining the first number comprises, after the third number is determined: determining, from the one or more first candidate numbers, a first candidate number that is associated with the determined third number as the first number. In some embodiments, when the RA procedure is a Type 2 RA procedure, the step of determining the third number comprises, after the first number is determined: determining, from the one or more third candidate numbers, a third candidate number that is associated with the determined first number as the third number. In some embodiments, the one or more first candidate numbers are ordered in an increasing order by their values and are indexed, wherein the one or more third candidate numbers are ordered in an increasing order by their values and are indexed, wherein a first candidate number is associated with a third candidate number when their indices are equal to each other. In some embodiments, the first number is equal to the third number.

In some embodiments, when the one or more parameters comprise the preamble index, the step of determining the first number comprises: determining a number associated with a preamble as the first number, wherein the preamble is indicated by the preamble index and is to be transmitted in a RACH occasion (RO) associated with a selected SSB. In some embodiments, the one or more parameters further comprise a mapping between the preamble index and the number associated with the preamble. In some embodiments, the preamble index is an index relative to the first preamble associated with the selected SSB in the RO. In some embodiments, when the one or more parameters comprise the identifier, the step of determining the first number comprises: determining a number associated with a resource as the first number, wherein the resource is indicated by the identifier and is used for at least one of the first number of PRACH transmissions.

In some embodiments, the one or more parameters comprise at least one of: one or more first parameters for a Type 1 RA procedure; and one or more second parameters for a Type 2 RA procedure; and one or more third parameters for both a Type 1 RA procedure and a Type 2 RA procedure. In some embodiments, the step of determining at least one of the first number and the second number comprises at least one of: determining at least one of the first number and the second number based on at least the one or more first parameters when the RA procedure is a Type 1 RA procedure; determining at least one of the first number, the second number, and the third number based on at least the one or more second parameters when the RA procedure is a Type 2 RA procedure; and determining at least one of the first number, the second number, and the third number based on at least the one or more third parameters no matter whether the RA procedure is a Type 1 RA procedure or a Type 2 RA procedure.

In some embodiments, when the RA procedure is a Type 2 RA procedure, the method further comprises: performing a single PRACH transmission as the initial MsgA PRACH transmission; and performing the first number of PRACH transmissions in response to determining that the initial MsgA PRACH transmission fails. In some embodiments, at least one of the one or more parameters is provided in at least one of: a CFRA configuration; a PDCCH order; and a BFR configuration. In some embodiments, when the RA procedure is performed for BFR, the one or more parameters further comprise a timer indicating how long the UE can perform the RA procedure, such that the first number of PRACH transmissions are expected to be completed before the timer expires.

In some embodiments, the RA procedure is a CFRA procedure or a CBRA procedure. In some embodiments, when the UE supports multiple PRACH transmissions for Type-1 CFRA and/or Type-1 CBRA, the UE also supports repetition of PUSCH scheduled by RAR. In some embodiments, when the UE supports multiple PRACH transmissions for Type-2 CFRA and/or Type-2 CBRA, the UE also supports repetition of MsgA PUSCH. In some embodiments, the method further comprises: receiving, from the network node, a RAR; determining how to interpret the received RAR based on at least whether one or more conditions are met or not. In some embodiments, the step of determining how to interpret the received RAR comprises at least one of: determining that the received RAR is to be interpreted in the Rel-17 repurposed way in response to determining that the one or more conditions are met; and determining that the received RAR is to be interpreted in the Rel-15 way in response to determining that the one or more conditions are not met. In some embodiments, when the received RAR is to be interpreted in the Rel-17 repurposed way, a Modulation and Coding Scheme (MCS) field in the received RAR is to be interpreted in the Rel-17 repurposed way.

In some embodiments, when the RA procedure is a CFRA procedure, the one or more conditions comprise at least one of: CFRA resources for multiple PRACH transmissions with only K>1 are configured; CFRA resources for multiple PRACH transmissions with K≥1 are configured, regardless of single or multiple PRACH transmissions of the CFRA resources; and CFRA resources for multiple PRACH transmissions with K≥1 are configured and the UE initiates multiple PRACH transmissions with K>1 using CFRA resources, where K is any of the one or more first candidate numbers.

In some embodiments, when the RA procedure is a CFRA procedure and when the CFRA procedure is triggered by a PDCCH order, the method further comprises: receiving, from the network node, a RAR; determining how to interpret the received RAR based on at least the PDCCH order. In some embodiments, the step of determining how to interpret the received RAR comprises: determining that the received RAR is to be interpreted in the Rel-17 repurposed way when the PDCCH order indicates multiple PRACH transmissions; and determining that the received RAR is to be interpreted in the Rel-15 way when the PDDCH order does not indicate multiple PRACH transmissions. In some embodiments, when the received RAR is to be interpreted in the Rel-17 repurposed way, an MCS field in the received RAR is to be interpreted in the Rel-17 repurposed way.

In some embodiments, when the RA procedure is a CBRA procedure, the method further comprises: receiving, from the network node, a RAR; determining how to interpret the received RAR based on at least one of: whether Msg3 repetition is configured in System Information Block 1 (SIB1); and whether multiple PRACH transmissions are performed. In some embodiments, the step of determining how to interpret the received RAR comprises at least one of: determining that the received RAR is to be interpreted in the Rel-17 repurposed way in response to determining that Msg3 repetition is configured in SIB1 and that multiple PRACH transmissions are performed; and determining that the received RAR is to be interpreted in the Rel-15 way in response to determining that Msg3 repetition is not configured in SIB1 and/or that multiple PRACH transmissions are not performed. In some embodiments, when the received RAR is to be interpreted in the Rel-17 repurposed way, an MCS field in the received RAR is to be interpreted in the Rel-17 repurposed way.

According to a second aspect of the present disclosure, a UE is provided. The UE comprises: a processor; a memory storing instructions which, when executed by the processor, cause the processor to perform any of the methods of the first aspect.

According to a third aspect of the present disclosure, a UE for performing an RA procedure is provided. The UE comprises: a receiving module configured to receive, from a network node, one or more parameters; and a determining module configured to determine, based on at least the one or more parameters, at least one of: a first number of PRACH transmissions; a second number of PUSCH transmissions scheduled by a RAR associated with the RA procedure; and a third number of MsgA PUSCH transmissions. In some embodiments, the UE may comprise one or more further modules, each of which may perform any of the methods of the first aspect.

According to a fourth aspect of the present disclosure, a method at a network node for performing an RA procedure with a UE is provided. The method comprises: transmitting, to the UE, one or more parameters; and receiving, from the UE, at least one of: a first number of PRACH transmissions; a second number of PUSCH transmissions scheduled by a RAR associated with the RA procedure; and a third number of MsgA PUSCH transmissions, wherein at least one of the first number, the second number, and the third number is determined by the UE based on at least the one or more parameters.

In some embodiments, the one or more parameters comprise at least one of: one or more first candidate numbers of PRACH transmissions; one or more second candidate numbers of PUSCH transmissions scheduled by the RAR associated with the RA procedure; one or more third candidate numbers of MsgA PUSCH transmissions; a preamble index; an identifier indicating a resource within a RACH indication and partitioning configuration framework. In some embodiments, the one or more parameters further comprise at least one of: one or more offsets to a first threshold, the first threshold being used in determining whether the RA procedure without CE is to fall back from a CFRA procedure to a CBRA procedure; one or more second thresholds, each of which is used in determining whether the CFRA procedure is to fall back, at a corresponding CE level, from a CFRA procedure to a CBRA procedure; and a flag indicating that no fallback from a CFRA procedure to a CBRA procedure is allowed.

In some embodiments, the one or more parameters comprise at least one of: one or more first parameters for a Type 1 RA procedure; and one or more second parameters for a Type 2 RA procedure; and one or more third parameters for both a Type 1 RA procedure and a Type 2 RA procedure. In some embodiments, at least one of the one or more parameters is provided in at least one of: a CFRA configuration; a PDCCH order; and a BFR configuration. In some embodiments, when the RA procedure is performed for BFR, the one or more parameters further comprise a timer indicating how long the UE can perform the RA procedure, such that the first number of PRACH transmissions are expected to be completed before the timer expires.

In some embodiments, the RA procedure is a CFRA procedure or a CBRA procedure. In some embodiments, the method further comprises: receiving, from the UE, a message indicating that the UE supports multiple PRACH transmissions for Type-1 CFRA and/or Type-2 CBRA; and determining that the UE also supports repetition of PUSCH scheduled by RAR based on at least the received message. In some embodiments, the method further comprises: receiving, from the UE, a message indicating that the UE supports multiple PRACH transmissions for Type-2 CFRA and/or Type-2 CBRA; and determining that the UE also supports repetition of MsgA PUSCH.

In some embodiments, the method further comprises at least one of: determining how a RAR is to be interpreted by the UE based on at least whether one or more conditions are met or not; generating the RAR based on at least the determination; and transmitting, to the UE, the generated RAR. In some embodiments, the step of determining how a RAR is to be interpreted by the UE comprises at least one of: determining that the RAR is to be interpreted by the UE in the Rel-17 repurposed way in response to determining that the one or more conditions are met; and determining that the RAR is to be interpreted by the UE in the Rel-15 way in response to determining that the one or more conditions are not met. In some embodiments, when the RAR is to be interpreted by the UE in the Rel-17 repurposed way, an MCS field in the RAR is generated such that it is to be interpreted by the UE in the Rel-17 repurposed way. In some embodiments, when the RA procedure is a CFRA procedure, the one or more conditions comprise at least one of: CFRA resources for multiple PRACH transmissions with only K>1 are configured for the UE; CFRA resources for multiple PRACH transmissions with K≥1 are configured for the UE, regardless of single or multiple PRACH transmissions of the CFRA resources; and CFRA resources for multiple PRACH transmissions with K≥1 are configured for the UE and the UE initiates multiple PRACH transmissions with K>1 using CFRA resources, where K is any of the one or more first candidate numbers.

In some embodiments, when the RA procedure is a CFRA procedure and when the CFRA procedure is triggered by a PDCCH order, the method further comprises at least one of: determining how a RAR is to be interpreted by the UE based on at least the PDCCH order; generating the RAR based on at least the determination; and transmitting, to the UE, the generated RAR. In some embodiments, the step of determining how a RAR is to be interpreted by the UE comprises: determining that the RAR is to be interpreted by the UE in the Rel-17 repurposed way when the PDCCH order indicates multiple PRACH transmissions; and determining that the RAR is to be interpreted by the UE in the Rel-15 way when the PDDCH order does not indicate multiple PRACH transmissions. In some embodiments, when the RAR is to be interpreted by the UE in the Rel-17 repurposed way, an MCS field in the RAR is generated such that it is to be interpreted by the UE in the Rel-17 repurposed way.

In some embodiments, when the RA procedure is a CBRA procedure, the method further comprises at least one of: determining how a RAR is to be interpreted by the UE based on at least one of whether Msg3 repetition is configured in SIB1 and whether multiple PRACH transmissions are performed by the UE; generating the RAR based on at least the determination; and transmitting, to the UE, the generated RAR. In some embodiments, the step of determining how a RAR is to be interpreted by the UE comprises at least one of: determining that the RAR is to be interpreted by the UE in the Rel-17 repurposed way in response to determining that Msg3 repetition is configured in SIB1 and that multiple PRACH transmissions are performed; and determining that the RAR is to be interpreted by the UE in the Rel-15 way in response to determining that Msg3 repetition is not configured in SIB1 and/or that multiple PRACH transmissions are not performed. In some embodiments, when the RAR is to be interpreted by the UE in the Rel-17 repurposed way, an MCS field in the RAR is generated such that it is to be interpreted by the UE in the Rel-17 repurposed way.

According to a fifth aspect of the present disclosure, a network node is provided. The network node comprises: a processor; a memory storing instructions which, when executed by the processor, cause the processor to perform any of the methods of the fourth aspect.

According to a sixth aspect of the present disclosure, a network node for performing an RA procedure with a UE is provided. The network node comprises: a transmitting module configured to transmit, to the UE, one or more parameters; and a receiving module configured to receive, from the UE, at least one of: a first number of PRACH transmissions; a second number of PUSCH transmissions scheduled by a RAR associated with the RA procedure; and a third number of MsgA PUSCH transmissions, wherein at least one of the first number, the second number, and the third number is determined by the UE based on at least the one or more parameters. In some embodiments, the network node may comprise one or more further modules, each of which may perform any of the methods of the fourth aspect.

According to a seventh aspect of the present disclosure, a computer program comprising instructions is provided. The instructions, when executed by at least one processor, cause the at least one processor to carry out the method of any of the first or fourth aspect.

According to an eighth aspect of the present disclosure, a carrier containing the computer program of the seventh aspect is provided. The carrier is one of an electronic signal, optical signal, radio signal, or computer readable storage medium.

According to a ninth aspect of the present disclosure, a telecommunication system is provided. The telecommunication system comprises one or more UEs of the second aspect or the third aspect; and at least one network node of the fifth aspect or the sixth aspect.

### BRIEF DESCRIPTION OF THE DRAWINGS

FIG. 1 is a diagram illustrating an exemplary telecommunication network in which UEs and gNB may be operated according to an embodiment of the present disclosure.

FIG. 2 shows flow charts illustrating exemplary Type-1 and Type-2 RA procedures, respectively, with which a UE and gNB according to an embodiment of the present disclosure may be operable.

FIG. 3 is a diagram illustrating exemplary preamble groups used for signaling and configuring a CE RA procedure according to an embodiment of the present disclosure.

FIG. 4 is a flow chart illustrating an exemplary method at a UE for performing an RA procedure according to an embodiment of the present disclosure.

FIG. 5 is a flow chart illustrating an exemplary method at a network node for performing an RA procedure with a UE according to an embodiment of the present disclosure.

FIG. 6 schematically shows an embodiment of an arrangement which may be used in a UE or a network node according to an embodiment of the present disclosure.

FIG. 7 is a block diagram of an exemplary UE according to an embodiment of the present disclosure.

FIG. 8 is a block diagram of an exemplary network node according to an embodiment of the present disclosure.

FIG. 9 shows an example of a communication system in accordance with some embodiments of the present disclosure.

FIG. 10 shows an exemplary UE in accordance with some embodiments of the present disclosure.

FIG. 11 shows an exemplary network node in accordance with some embodiments of the present disclosure.

FIG. 12 is a block diagram of an exemplary host, which may be an embodiment of the host of FIG. 8, in accordance with various aspects described herein.

FIG. 13 is a block diagram illustrating an exemplary virtualization environment in which functions implemented by some embodiments may be virtualized.

FIG. 14 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as CE RA signaling and configuring is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

Further, following 3GPP documents are incorporated herein by reference in their entireties:
3GPP TS 38.321 V17.1.0 (2022-06), Technical Specification, 3rd Generation Partnership Project; Technical Specification Group Radio Access Network; NR; Medium Access Control (MAC) protocol specification (Release 17); and
3GPP TS 38.331 V17.1.0 (2022-06), Technical Specification, 3rd Generation Partnership Project; Technical Specification Group Radio Access Network; NR; Radio Resource Control (RRC) protocol specification (Release 17).

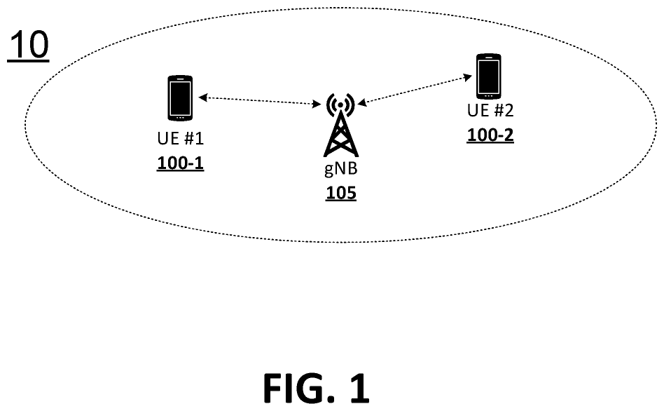

FIG. 1 is a diagram illustrating an exemplary telecommunication network 10 in which a UE #1 100-1, a UE #2 100-2, and a RAN node (e.g., gNB) 105 may be operated according to an embodiment of the present disclosure. Although the telecommunication network 10 is a network defined in the context of 5G NR, the present disclosure is not limited thereto.

As shown in FIG. 1, the network 10 may comprise one or more UEs 100-1 and 100-2 (collectively, UE(s) 100) and a RAN node 105, which could be a base station, a Node B, an evolved NodeB (eNB), a gNB, or an AN node which provides the UEs 100 with access to the network. Further, the network 10 may comprise its core network portion that is not shown in FIG. 1.

However, the present disclosure is not limited thereto. In some other embodiments, the network 10 may comprise additional nodes, less nodes, or some variants of the existing nodes shown in FIG. 1. For example, in a network with the 4G architecture, the entities (e.g., an eNB) which perform these functions may be different from those (e.g., the gNB 105) shown in FIG. 1. For another example, in a network with a mixed 4G/5G architecture, some of the entities may be same as those shown in FIG. 1, and others may be different.

Further, although two UEs 100 and one gNB 105 are shown in FIG. 1, the present disclosure is not limited thereto. In some other embodiments, any number of UEs and/or any number of gNBs may be comprised in the network 10.

As shown in FIG. 1, the UEs 100 may be communicatively connected to the gNB 105 which in turn may be communicatively connected to a corresponding Core Network (CN) and then the Internet, such that the UEs 100 may finally communicate its user plane data with other devices outside the network 10, for example, via the gNB 105.

When a UE wants to access to a 5G NR network, it has to synchronize in downlink as well as in uplink. Downlink synchronization may be obtained after successfully decoding SSB. In order to establish uplink synchronization and an RRC connection, the UE has to perform a random access procedure.

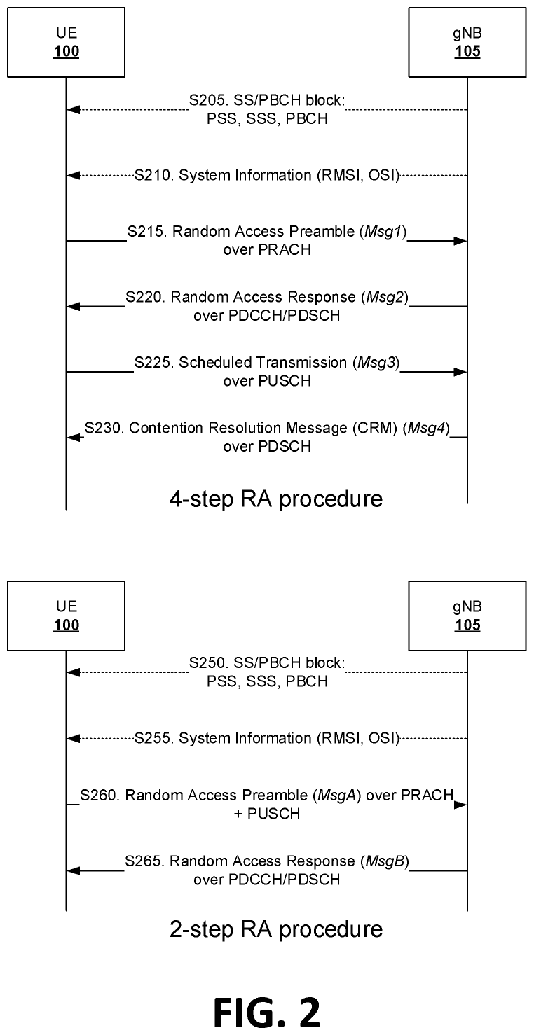

FIG. 2 shows flow charts illustrating exemplary Type-1 and Type-2 RA procedures, respectively, with which a UE 100 and gNB 105 according to an embodiment of the present disclosure may be operable. As shown in FIG. 2, there are two types of RA procedures:
Type-1 RA procedure, also known as 4-step RACH, or 4-step RA procedure; and
Type-2 RA procedure, also known as 2-step RACH, or 2-step RA procedure.

The two types of RA procedures may be triggered upon request of a PRACH transmission by higher layers of the UE 100 or by a PDCCH order from the gNB 105.

Further, RA procedures may also be classified into Contention Based Random Access (CBRA) or Non Contention or Contention Free Random Access (CFRA) depending on how its resource is selected. In the contention based RA procedure, the UE 100 may select a preamble randomly or in a pre-determined manner from a pool of preambles shared with other UEs. This means that the UE 100 has a potential risk of selecting a same preamble as another UE and subsequently may experience conflict or contention. The gNB 105 may use a contention resolution mechanism to handle this type of access requests. In this procedure, the result is random and not all RA succeeds.

In non-contention based Random Access or CFRA, the preamble may be pre-allocated by the gNB 105 and such preambles may be known as dedicated random access preamble. The dedicated preamble may be provided to the UE 100 either via RRC signalling (e.g., allocating preamble can be specified within an RRC message) or PHY Layer signalling (e.g., Downlink Control Information (DCI) on the PDCCH). Therefore, there is no preamble conflict. When dedicated resources are insufficient, the gNB 105 may instruct UEs to initiate contention-based RA.

Referring to the top flow chart of FIG. 2, an exemplary 4-step RA procedure may comprise four steps S215 to S230 for the UE 100 to access the gNB 105 after necessary system information, which is broadcasted by the gNB 105, is obtained at the steps S205 and S210. Please note that although FIG. 2 shows an exemplary CBRA procedure of Type-1, the present disclosure is not limited thereto. For example, in some other embodiments, a CFRA procedure of Type-1 is also possible.

At step S205, the UE 100 may receive a Master Information Block (MIB) from the gNB 105 by detecting an SSB which may comprise a Primary Synchronous Signal (PSS), a Secondary Synchronous Signal (SSS), and a PBCH carrying the MIB. Upon successful reception and decoding of the MIB, the UE 100 may determine time/frequency positions for monitoring Remaining Minimum System Information (RMSI) or System Information Block 1 (SIB1) broadcasted by the gNB 105, for example, by a pdcch-ConfigSIB1 information element (IE) comprised in the MIB.

At step S210, the UE 100 may receive the RMSI and Other System Information (OSI) from the gNB 105. For example, the UE 100 may receive and decode the RMSI (SIB1) based on the information determined at the step S205 to determine time/frequency positions for monitoring OSI broadcasted by the gNB 105, for example, by a searchSpaceOtherSystemInformation IE comprised in the SIB1. Further, the UE 100 may also obtain any parameters necessary for the 4-step RA procedure. For example, the UE 100 may determine a set of preambles by a RACH-ConfigCommon IE which can be used later during the 4-step RA procedure.

At step S215, the UE 100 may transmit a preamble which is selected from the set of preambles determined at the step S210 to the gNB 105 in Msg1. As mentioned above, the preamble may be a preamble associated with CBRA. Further, in some other embodiments where CFRA is to be performed by the UE 100, an RA preamble associated with CFRA may be allocated by the gNB 105 to the UE 100 before step S215, for example, by using an RRC message or DCI signaling. Some scenarios for CFRA are listed below:
Handover: The MobilityControlInfo IE sent by the source gNB may carry the allocated preamble;
Downlink (DL) Data Arrival: When downlink data arrives at the gNB 105, the gNB 105 may instruct the UE 100 to initiate an RA procedure through DCI over PDCCH, which carries the allocated preamble;
Non-Standalone (NSA) networking: When NR cells are added in NSA, the gNB 105 may instruct the UE 100 to initiate an RA procedure through the PDCCH, which carries the allocated preamble.

At step S220, upon reception of Msg1, the gNB 105 may select a Temporary Cell-Radio Network Temporary Identifier (TC-RNTI) and uplink and downlink scheduling resources for the UE 100. Then, the gNB 105 may transmit an RA response (RAR or Msg2) over PDCCH/PDSCH. The response may contain the RA-preamble identifier, timing alignment information, initial uplink grant, and the TC-RNTI. One PDSCH may carry RA responses to multiple UEs. The Msg2 is said to consist of a PDCCH that assigns the PDSCH reception, where the PDSCH reception may contain a RAR MAC Protocol Data Unit (PDU). The RAR MAC PDU may further contain several fields such as providing the Timing Advance Command used to align the timing of the UE and the Temporary RNTI and the UL grant which are used to scramble and schedule the Msg3, respectively.

On the other hand, after transmitting the preamble, the UE 100 may monitor the PDCCH and wait for the RAR within an RA response window:
If the UE 100 receives a response containing an RA-preamble identifier which is the same as the identifier contained in the transmitted RA preamble, the response is successful. The UE 100 may then transmit uplink scheduling information later.
If the UE 100 does not receive a response within the RA response window or fails to verify the response, the response fails. In this case, if the number of RA attempts is less than the upper limit (e.g., 10), the UE 100 may retry the RA procedure. Otherwise, the RA procedure fails.

Further, the UE 100 may use the timing alignment information comprised in the RAR to adjust the timing of any subsequent PUSCH transmission, allowing PUSCH to be received at the gNB 105 with a timing accuracy within the cyclic prefix (CP). Without this timing advance functionality, a very large CP would be needed in order to be able to demodulate and detect PUSCH, unless the system is applied in a cell with very short distance between the UE 100 and the gNB 105. Since NR will also support larger cells, there is a need for providing a timing advance to the UE 100.

At step S225, the UE 100 may transmit uplink scheduling information (Msg3) over the PUSCH. The signaling messages and information transmitted by the UE 100 may vary across different RA scenarios and some examples are listed below:
Initial RRC connection setup: The RRCSetupRequest message (carrying NAS UE_ID) is transmitted over the common control channel (CCCH) in Transparent Mode (TM) at the RLC layer. The message is not segmented.
RRC connection reestablishment: The RRC Reestablishment Request message (not carrying the NAS message) is transmitted over the CCCH in TM at the RLC layer. The message is not segmented.
Handover: Contention-based RA, instead of contention-free RA, is triggered if the UE 100 accesses the target cell and no dedicated preambles are available during a handover. The RRC Handover Confirm message and C-RNTI are transmitted over the dedicated control channel (DCCH). If required, a buffer status report (BSR) may also be carried.
Other scenarios: At least the C-RNTI of the UE 100 may be transmitted.

At step S230, after transmitting the Msg3, a contention resolution timer may be started at the UE 100. The gNB 105 may assist the UE 100 in contention resolution using the C-RNTI on the PDCCH or using the UE Contention Resolution Identity IE on the PDSCH.

The UE 100 may keep monitoring the PDCCH before the timer expires and considers the contention resolution successful and stops the timer if either of the following conditions is met:
The UE 100 receives a PDCCH on its C-RNTI.
The UE 100 successfully decodes the MAC PDU addressed by the temporary C-RNTI. Specifically, the UE Contention Resolution Identity IE received over the PDSCH is the same as that carried in Msg3 sent by the UE.

If the contention resolution timer expires, the UE 100 may consider the contention resolution failed. Then, the UE 100 may perform the RA procedure again if the number of RA attempts has not reached the upper limit. If the number of RA attempts has reached its upper limit, the RA procedure fails.

Referring to the bottom flow chart of FIG. 2, an exemplary 2-step RA procedure may comprise two steps S260 and S265 for a UE 100 to access a gNB 105 after necessary system information, which is broadcasted by the gNB 105, is obtained at the steps S250 and S255. Please note that although FIG. 2 shows an exemplary CFRA procedure of Type-2, the present disclosure is not limited thereto. For example, in some other embodiments, a CBRA procedure of Type-2 is also possible.

Similar to the step S205, at step S250, the UE 100 may receive a MIB from the gNB 105 by detecting an SSB. Upon successful reception and decoding of the MIB, the UE 100 may determine time/frequency positions for monitoring RMSI or SIB1 broadcasted by the gNB 105.

Similar to the step S210, at step S255, the UE 100 may receive the RMSI and OSI from the gNB 105. For example, the UE 100 may receive and decode the RMSI (SIB1) based on the information determined at the step 105 to determine time/frequency positions for monitoring OSI broadcasted by the gNB 105, for example, by a searchSpaceOtherSystemInformation IE comprised in the SIB1. Further, the UE 100 may also obtain any parameters necessary for the 2-step RA procedure. For example, the UE 100 may determine available time/frequency occasions for PRACH by a msgA-ConfigCommon IE comprised in the SIB1, which can be used later during the 2-step RA procedure.

Similar to the step S215, at the step S260, the UE 100 may transmit to the gNB 105 an RA preamble, which may be pre-allocated by the gNB 105 when it is a CFRA procedure, together with higher layer data such as an RRC connection request possibly with some small additional payload on PUSCH (MsgA). In such a case, no confliction with other UEs will happen.

Similar to the step S220, the gNB 105 may transmit an RA response (MsgB) to the UE 100. Since no conflict with other UEs will occur, and the steps for contention resolving may be omitted.

In the handover scenario, the RA response may contain the timing alignment information and initial uplink grant. In the DL data arrival scenario, when downlink data arrives at the gNB 105, the RA response may contain the timing alignment information and RA preamble identifier (RAPID). In the NSA networking scenario, when NR cells are added in NSA, the RA response may contain the timing alignment information and RAPID.

Further, in the 2-step RA procedure, if the network (e.g., the gNB 105) is able to decode the MsgA preamble but not the MsgA PUSCH, the gNB 105 may order the UE 100 to fallback to a 4-step RA procedure with a fallback RAR. The fallback RAR may schedule a Msg3 in the 4-step RA procedure.

RACH repetition was introduced in Rel-13 Work Items (WIs) of “Further LTE Physical Layer Enhancements for Machine Type Communication (MTC)” and “NarrowBand Internet-of-Things (NB-IOT)” to extend coverage.

RACH Repetition for LTE Enhanced MTC (eMTC), NB-IOT

Repetition of the information is the main technique to achieve coverage enhancements. It is used for all physical channels available for coverage enhanced UEs, e.g., M-PDCCH, PBCH, PDSCH, PUCCH, PUSCH, and PRACH.

A UE may decide a repetition level for an initial PRACH transmission. The repetition levels that a cell supports (e.g. 5, 10, and 15 dB) may be included in the system information and the UE may select one of these based on e.g. the estimated channel quality.

During an initial random access:
UE measures the DL quality;
UE selects a suitable repetition level for its initial PRACH preamble transmission among 4 levels;
If the UE does not receive a RAR, it increases its PRACH repetition level;
Numbers of repetitions for RAR and following messages will depend on the level for the successful PRACH.

Coverage enhancement for the physical random access PRACH preamble can be achieved partly through relaxation of the required PRACH misdetection probability and partly through repetition of the legacy PRACH formats. A maximum of three different repetition levels (plus the zero coverage enhancement level) can be configured, where each level has its own configurable number of repetitions and attempts in order to adapt to the UE's coverage situation. For initial random access, the UE may choose its repetition level based on RSRP measurements. If the UE does not receive a RAR after the maximum number of attempts of its current level, it may move to the next higher one. In some embodiments, no power ramping is used for large repetition levels; otherwise the current procedure is used. Different coverage levels may correspond to different PRACH resources (e.g. different combinations of preamble sequences, timing, and narrowbands) and the available resources may be signalled in SIB.

The RAR message may be scheduled with M-PDCCH and an associated PDSCH. The UE knows the repetition level, possible start subframe, and frequency resource of the M-PDCCH from its most recent PRACH transmission (in combination with information signalled in SIB).

To enable different operation modes depending on a UE's need of coverage extension, two coverage enhancement modes have been introduced for RRC_CONNECTED UES:
CE mode A for no or small coverage enhancement, requiring a few (e.g. up to a few tens of) repetitions.
CE mode B for a medium to large coverage enhancement, requiring several (e.g. hundreds of) repetitions.
The CE mode is signalled to the UE by the network.

Coverage enhancement modes: As mentioned earlier, the UE moves from no or small coverage enhancements (CE mode A) to large coverage enhancements (CE mode B) when signalled. The idea is to only keep a UE in CE mode B if it is not able to do synchronization acquisition, system information acquisition, random access, or data transmission using small coverage operation. In enhanced coverage operation, the number of repetitions can be adapted according to the UE's coverage situation.

### 3GPP TS 36.321 v17.0.0:

If the UE is a BL UE or a UE in enhanced coverage:

| | |
|---|---|
| - | if the random access preamble was transmitted in a non-terrestrial network: |
| - | RA Response window starts at the subframe that contains the end of the last preamble repetition |

```
    plus 3 + UE-eNB RTT subframes, as specified in TS 36.213 [6] clause X.X and has length ra-
    ResponseWindowSize for the corresponding enhanced coverage level;
```

| | |
|---|---|
| - | else: |
| - | RA Response window starts at the subframe that contains the end of the last preamble repetition |

```
    plus three subframes and has length ra-ResponseWindowSize for the corresponding enhanced
    coverage level.
If the UE is an NB-IoT UE:
```

| | |
|---|---|
| - | if the random access preamble was transmitted in a non-terrestrial network: |
| - | RA Response window starts at the subframe that contains the end of the last preamble repetition |

```
    plus X + UE-eNB RTT subframes, as specified in TS 36.213 [6] clause X.X and has length ra-
    ResponseWindowSize for the corresponding enhanced coverage level, where value X is
    determined from Table 5.1.4-1 based on the used preamble format and the number of NPRACH
    repetitions;
```

| | |
|---|---|
| - | else: |
| - | RA Response window starts at the subframe that contains the end of the last preamble repetition |

```
    plus X subframes and has length ra-ResponseWindowSize for the corresponding enhanced
    coverage level, where value X is determined from Table 5.1.4-1 based on the used preamble
    format and the number of NPRACH repetitions.
The RA-RNTI associated with the PRACH in which the Random Access Preamble is transmitted, is
computed as:
```

RA-RNTI= 1 + t_id + 10*f_id

where t_id is the index of the first subframe of the specified PRACH (0≤ t_id <10), and f_id is the index of
the specified PRACH within that subframe, in ascending order of frequency domain (0≤ f_id< 6) except
for NB-IoT UEs, BL UEs or UEs in enhanced coverage. If the PRACH resource is on a TDD carrier, the
f_id is set to f_{RA}, where f_{RA} is defined in clause 5.7.1 of TS 36.211 [7].
For BL UEs and UEs in enhanced coverage, RA-RNTI associated with the PRACH in which the Random
Access Preamble is transmitted, is computed as:

RA-RNTI=1+t_id + 10*f_id + 60*(SFN_id mod (Wmax/10))

where t_id is the index of the first subframe of the specified PRACH (0≤ t_id <10), f_id is the index of the
specified PRACH within that subframe, in ascending order of frequency domain (0≤ f_id< 6), SFN_id is
the index of the first radio frame of the specified PRACH, and Wmax is 400, maximum possible RAR
window size in subframes for BL UEs or UEs in enhanced coverage. If the PRACH resource is on a TDD
carrier, the f_id is set to f_{RA}, where f_{RA} is defined in clause 5.7.1 of TS 36.211
For NB-IoT UEs, the RA-RNTI associated with the PRACH in which the Random Access Preamble is
transmitted, is computed as:

RA-RNTI=1 + floor(SFN_id/4) + 256*carrier_id

where SFN_id is the index of the first radio frame of the specified PRACH and carrier_id is the index of
the UL carrier associated with the specified PRACH. The carrier_id of the anchor carrier is 0.

LTE eMTC (Section 5.7.1 in 36.211)

```
For BL/CE UEs, for each PRACH coverage enhancement level, there is a PRACH configuration
configured by higher layers with a PRACH configuration index (prach-ConfigurationIndex), a PRACH
$frequency offset {\overline{n}}_{P RBoffset}^{RA} ( prach - FrequencyOffset ) , a number of PRACH repetitions per attempt$
${N}_{r e p}^{PRACH} ( numRepetitionPerPreambleAttempt ) and optionally a PRACH starting subframe periodicity$
${N}_{start}^{P R A C H} ( prach - StartingSubframe ) . PRACH of preamble format 0 - 3 is transmitted {N}_{r e p}^{P R C H} \geq 1 times ,$
whereas PRACH of preamble format 4 is transmitted one time only.
For BL/CE UEs and for each PRACH coverage enhancement level, if frequency hopping is enabled for a
PRACH configuration by the higher-layer parameter prach-HoppingConfig, the value of the parameter
${n}_{P RBoffset}^{R A} depends on the SFN and the PRACH configuration index and is given by$
  - In case the PRACH configuration index is such that a PRACH resource occurs in every radio frame when
calculated as below from Table 5.7.1-2 or Table 5.7.1-4,
      ${n}_{P RBoffset}^{RA} = \{ \begin{matrix}{\overline{n}}_{PRBoffset}^{RA} & if {n}_{f} mod 2 = 0 \\ ( {\overline{n}}_{PRBoffset}^{RA} + {f}_{PRB , hop}^{PRACH} ) mod {N}_{P B}^{U L} & if {n}_{f} mod 2 = 1\end{matrix}$
  - otherwise
      ${n}_{PRBoffset}^{RA} = \{ \begin{matrix}{\overline{n}}_{PRBoffset}^{RA} & if ⌊ \frac{{n}_{f} mod 4}{2} ⌋ = 0 \\ ( {\overline{n}}_{PRBoffset}^{RA} + {f}_{PRB , hop}^{PRACH} ) mod {N}_{P B}^{U L} & if ⌊ \frac{{n}_{f} mod 4}{2} ⌋ = 1\end{matrix}$
where n_{f} is the system frame number corresponding to the first subframe for each PRACH repetition,
${f}_{PRB , hop}^{PRACH} corresponds to a cell - specific higher - layer parameter prach - HoppingOffset . If frequency hopping$
$is not enabled for the PRACH configuration then {n}_{PRBoffset}^{R A} = {\overline{n}}_{PRBoffset}^{R A} .$
For frame structure type 1 with preamble format 0-3, for each of the PRACH configurations there is at
most one random access resource per subframe.
For frame structure type 2 with preamble formats 0-4, for each of the PRACH configurations there might
be multiple random access resources in an UL subframe (or UpPTS for preamble format 4) depending on
the UL/DL configuration [see table 4.2-2]. Table 5.7.1-3 lists PRACH configurations allowed for frame
structure type 2 where the configuration index corresponds to a certain combination of preamble format,
PRACH density value, D_{RA} and version index, r_{RA}.
For frame structure type 2 with PRACH configuration indices 0, 1, 2, 20, 21, 22, 30, 31, 32, 40, 41, 42, 48,
49, 50, or with PRACH configuration indices 51, 53, 54, 55, 56, 57 in UL/DL configuration 3, 4, 5, the UE
may for handover purposes assume an absolute value of the relative time difference between radio frame
i in the current cell and the target cell is less than [symbol]
Table 5.7.1-3: Frame structure type 2 random access configurations for preamble formats 0-4
```

| PRACH | | Density | | PRACH | | Density | |
|---|---|---|---|---|---|---|---|
| configuration | Preamble | Per 10 ms | Version | configuration | Preamble | Per 10 ms | Version |
| Index | Format | D_{RA} | r_{RA} | Index | Format | D_{RA} | r_{RA} |
| 0 | 0 | 0.5 | 0 | 32 | 2 | 0.5 | 2 |
| 1 | 0 | 0.5 | 1 | 33 | 2 | 1 | 0 |
| 2 | 0 | 0.5 | 2 | 34 | 2 | 1 | 1 |
| 3 | 0 | 1 | 0 | 35 | 2 | 2 | 0 |

```
Table 5.7.1-4 lists the mapping to physical resources for the different random access opportunities
$needed for a certain PRACH density value , {D}_{RA} . Each quadruple of the format ( {f}_{RA} , {t}_{RA}^{( 0 )} , {t}_{RA}^{( 1 )} , {t}_{RA}^{( 2 )} )$
indicates the location of a specific random access resource, where f_{RA} is a frequency resource index
$within the considered time instance , {t}_{RA}^{( 0 )} = 0 , 1 , 2 indicates whether the resource is reoccuring in all radio$
$frames , in even radio frames , or in odd radio frames , respectively , {t}_{RA}^{( 1 )} = 0 , 1 indicates whether the random$
$access resource is located in first half frame or in second half frame , respectively , and where {t}_{RA}^{( 2 )} is the$
uplink subframe number where the preamble starts, counting from 0 at the first uplink subframe between 2
$consecutive downlink - to - uplink switvh points , with the exception of pramble format 4 where {t}_{RA}^{( 2 )} is$
denoted as (*). The start of the random access preamble formats 0-3 shall be aligned with the start of the
corresponding uplink subframe at the UE assuming N_{TA} = 0 and the random access preamble format 4
shall start 4832 · Tₛ before the end of the UpPTS at the UE, where the UpPTS is referenced to the UE's
uplink frame timing assuming N_{TA} = 0.
The random access opportunities for each PRACH configuration shall be allocated in time first and then in
frequency if and only if time multiplexing is not sufficient to hold all opportunities of a PRACH configuration
needed for a certain density value D_{RA} without overlap in time. For preamble format 0-3, the frequency
multiplexing shall be done according to
      ${n}_{PRB}^{RA} = \{ \begin{matrix}{n}_{PRB offset}^{RA} + 6 ⌊ \frac{{f}_{RA}}{2} ⌋ , & if {f}_{RA} mod 2 = 0 \\ {N}_{RB}^{UL} - 6 - {n}_{PRBoffset}^{RA} - 6 ⌊ \frac{{f}_{RA}}{2} ⌋ , & otherwise\end{matrix}$
$where {N}_{RB}^{UL} is the number of uplink resource blocks , {n}_{PRB}^{RA} is the first physical resource block allocated to$
$the PRACH opportunity considered and where {n}_{PRB offset}^{RA} is the first physical resource block available for$
PRACH.
For BL/CE UEs, only a subset of the subframes allowed for preamble transmission are allowed as starting
$subframes for the {N}_{rep}^{PRACH} repetitions . The allowed starting subframes for a PRACH configuration are$
determined as follows:
  - Enumerate the subframes that are allowed for preamble transmission for the PRACH configuration as
  ${n}_{sf}^{RA} = 0 , … {N}_{sf}^{RA} - 1 where {n}_{sf}^{RA} = 0 and {n}_{sf}^{RA} = {N}_{sf}^{RA} - 1 correspond to the two subframes allowed for preamble$
  $transmission with the smallest and the largest absolute subframe number {n}_{sf}^{abs} , respectively .$
  - $If a PRACH starting subframe periodicity {N}_{start}^{PRACH} is not provided by higher layers , the periodicity of the$
  $allowed starting subframes in terms of subframes allowed for preamble transmission is {N}_{rep}^{PRCH} . The allowed$
  $starting subframes defined over {n}_{sf}^{RA} = 0 , … {N}_{sf}^{RA} - 1 are given by {jN}_{rep}^{PRACH} where j = 0 , 1 , 2 , …$
  - $If a PRACH starting subframe periodicity {N}_{start}^{P R A C H} is provided by higher layers , it indicates the periodicity$
  of the allowed starting subframes in terms of subframes allowed for preamble transmission. The allowed starting
  $subframes defined over {n}_{s f}^{R A} = 0 , … {N}_{s f}^{R A} - 1 are given by {jN}_{start}^{PRACH} + {N}_{r e p}^{PRACH} where j = 0 , 1 , 2 , …$
  - $No starting subframe defined over {n}_{s f}^{R A} = 0 , … {N}_{s f}^{R A} - 1 such that {n}_{s f}^{RA} > {N}_{s f}^{RA} - {N}_{r e p}^{PRACH} is allowed .$
Each random access preamble occupies a bandwidth corresponding to 6 consecutive resource blocks for
both frame structures.
Table 5.7.1-4: Frame structure type 2 random access preamble mapping in time and frequency
```

| PRACH | | | | | | | |
|---|---|---|---|---|---|---|---|
| configuration Index | UL/DL configuration (See Table 4.2-2) | | | | | | |
| (See Table 5.7.1-3) | 0 | 1 | 2 | 3 | 4 | 5 | 6 |
| 0 | (0, 1, 0, 2) | (0, 1, 0, 1) | (0, 1, 0, 0) | (0, 1, 0, 2) | (0, 1, 0, 1) | (0, 1, 0, 0) | (0, 1, 0, 2) |
| 1 | (0, 2, 0, 2) | (0, 2, 0, 1) | (0, 2, 0, 0) | (0, 2, 0, 2) | (0, 2, 0, 1) | (0, 2, 0, 0) | (0, 2, 0, 2) |
| 2 | (0, 1, 1, 2) | (0, 1, 1, 1) | (0, 1, 1, 0) | (0, 1, 0, 1) | (0, 1, 0, 0) | N/A | (0, 1, 1, 1) |

### NB-IoT (Section 10.1.6 of 36.211)

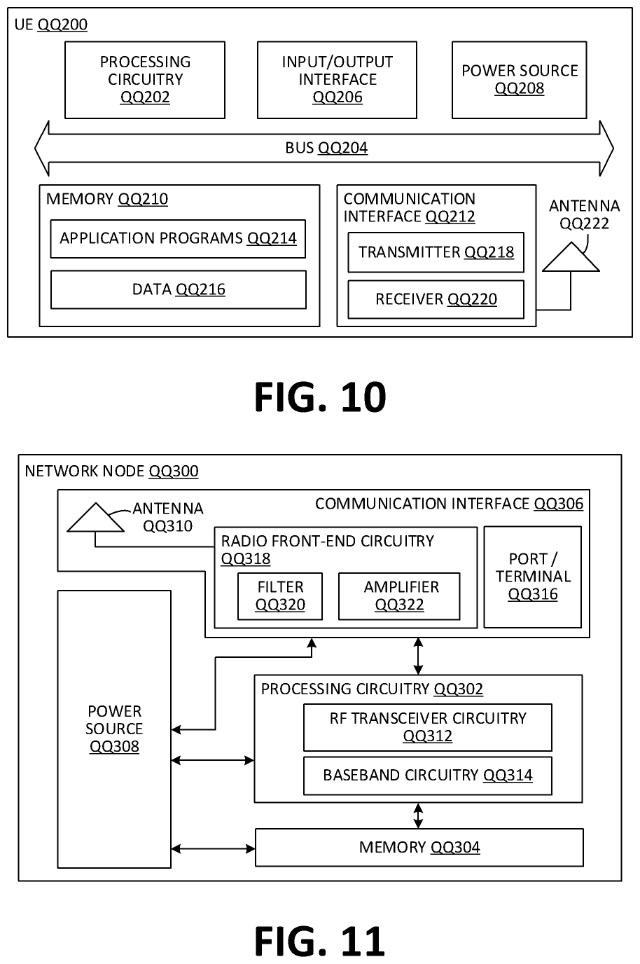

The physical layer random access preamble is based on single-subcarrier frequency-hopping symbol groups.
A symbol group is illustrated in FIG. 10.1.6.1-1, consisting of a cyclic prefix of length T_{CP} and a sequence
of N identical symbols with total length T_{SEQ}. The total number of symbol groups in a preamble repetition unit
is denoted by P. The number of time-contiguous symbol groups is given by G.
Table 10.1.6.1-2: Random access preamble parameters for frame structure type 2

| | Supported | | | | | |
|---|---|---|---|---|---|---|
| | uplink- | | | | | |
| | downlink | | | | | |
| Preamble format | configurations | G | P | N | T_{CP} | T_{SEQ} |
| 0 | 1, 2, 3, 4, 5 | 2 | 4 | 1 | 4768Tₛ | 1 · 8192Tₛ |
| 1 | 1, 4 | 2 | 4 | 2 | 8192Tₛ | 2 · 8192Tₛ |
| 2 | 3 | 2 | 4 | 4 | 8192Tₛ | 4 · 8192Tₛ |
| 0-a | 1, 2, 3, 4, 5 | 3 | 6 | 1 | 1536Tₛ | 1 · 8192Tₛ |
| 1-a | 1, 4 | 3 | 6 | 2 | 3072Tₛ | 2 · 8192Tₛ |

$The preamble consisting of P symbol groups shall be transmitted {N}_{rep}^{NPRACH} times . For frame$
structure type 2, when an invalid uplink subframe overlaps the transmission of G symbol groups
without a gap, the G symbol groups are dropped. For frame structure type 2, the transmission of
G symbol groups are aligned with the subframe boundary.
$The frequency location of the NPRACH transmission is constrained within {N}_{s c}^{R A} = 12 sub - carriers ,$
$and within {N}_{sc}^{R A} = 36 subcarriers when preamble format 2 as described in Table 10.1 \text{.6} \text{.1} - 1 is$
configured. Frequency hopping shall be used within the 12 subcarriers and 36 subcarriers when
preamble format 2 as described in Table 10.1.6.1-1 is configured, where the frequency location
$of the {i}^{th} symbol group is given by {n}_{s c}^{R A} ( i ) = {n}_{start} + {\tilde{n}}_{S C}^{R A} ( i ) where {n}_{start} = {N}_{scoffset}^{N P R A C H} + ⌊ {n}_{init} / {N}_{s c}^{R A} ⌋ \cdot {N}_{sc}^{R A} .$
$The quantity {\tilde{n}}_{s c}^{RA} ( i ) depends on the frame structure .$

### Msg1 Power Determination

### Section 7.4 of 3GPP TS 38.213 v17.1.0

A PRACH is transmitted using the selected PRACH format with transmission power P_{PRACH,b,f,c}(i) on the
indicated PRACH resource, with BWP b of carrier f of serving cell c.
P_{PRACH,b,f,c}(i) = min{P_{CMAX,f,c}(i), P_{PRACH,target,b,f,c}(i) + PL_{b,f,c}} [dBm]
If within a random access response window, as described in Clause 8.2, the UE does not receive a
random access response that contains a preamble identifier corresponding to the preamble sequence
transmitted by the UE, the UE determines a transmission power for a subsequent PRACH transmission,
if any, as described in [11, TS 38.321].
If prior to a PRACH retransmission, a UE changes the spatial domain transmission filter, Layer 1
notifies higher layers to suspend the power ramping counter as described in [11, TS 38.321].
5.1.3 of 38.321 v17.0.0
The MAC entity shall, for each Random Access Preamble:

| | |
|---|---|
| 1> | if PREAMBLE_TRANSMISSION_COUNTER is greater than one; and |
| 1> | if the notification of suspending power ramping counter has not been received from lower layers; and |
| 1> | if SSB or CSI-RS selected is not changed from the selection in the last Random Access Preamble |

transmission:

| | |
|---|---|
| 2> | increment PREAMBLE_POWER_RAMPING_COUNTER by 1. |
| 1> | select the value of DELTA_PREAMBLE according to clause 7.3; |
| 1> | set PREAMBLE_RECEIVED_TARGET_POWER to preambleReceivedTargetPower + |

```
  DELTA_PREAMBLE + (PREAMBLE_POWER_RAMPING_COUNTER − 1) ×
  PREAMBLE_POWER_RAMPING_STEP;
```

| | |
|---|---|
| 1> | except for contention-free Random Access Preamble for beam failure recovery request, compute the RA- |

RNTI associated with the PRACH occasion in which the Random Access Preamble is transmitted;

| | |
|---|---|
| 1> | instruct the physical layer to transmit the Random Access Preamble using the selected PRACH occasion, |

corresponding RA-RNTI (if available), PREAMBLE_INDEX and PREAMBLE_RECEIVED_TARGET_POWER.

### Msg3 Transmission Power

### Section 7.1.1 of 3GPP TS 38.213 v17.1.0

```
If a UE transmits a PUSCH on active UL BWP b of carrier f of serving cell c using parameter set
configuration with index j and PUSCH power control adjustment state with index l, the UE determines
the PUSCH transmission power P_{PUSCH, b, f, c} (i, j, q_{d}, l) in PUSCH transmission occasion i as
${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} \\ ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \} [ dBm ]$
where,
. . .
  For the PUSCH power control adjustment state f_{b, f, c} (i, l) for active UL BWP b of carrier f of serving cell c
  in PUSCH transmission occasion i
. . .
    If the UE receives a random access response message in response to a PRACH transmission on active UL
    BWP b of carrier f of serving cell c as described in Clause 8
      - f_{b, f, c} (0, l) = ΔP_{rampup,b,f,c} + δ_{msg2,b,f,c}, where l = 0 and
        - δ_{msg 2,b,f,c} is a TPC command value indicated in the random access response grant of the random
        access response message corresponding to the PRACH transmission on active UL BWP b of carrier
          f in the serving cell c, and
        -
        $Δ {P}_{rampup , b , f , c} = min [ \{ max ( \begin{matrix}0 , {P}_{CMAX , f , c} - \\ ( \begin{matrix}10 {log}_{10} ( {2}^{μ} \cdot {M}_{RB , f , c}^{PUSCH} ( 0 ) ) + \\ \begin{matrix}{P}_{O \_ PUSCH , b , f , c} ( 0 ) + \\ {α}_{b , f , c} ( 0 ) \cdot {PL}_{c} +\end{matrix} \\ {Δ}_{TF , b , f , c} ( 0 ) + {δ}_{msg 2 , b , f , c}\end{matrix} )\end{matrix} ) \} , Δ {P}_{rampuprequested , b , f , c} ]$
        and ΔP_{rampuprequested,b,f,c} is provided by higher layers and corresponds to the total power ramp-up
        requested by higher layers from the first to the last random access preamble for carrier f in the
        $serving cell c , {M}_{RB , b , f , c}^{PUSCH} ( 0 ) is the bandwidth of the PUSCH resources assignment expressed in mumber$
        of resource blocks for the first PUSCH transmission on active UL BWP b of carrier f of serving cell
        c, and Δ_{TF,b,f,c} (0) is the power adjustment of first PUSCH transmission on active UL BWP b of
        carrier f of serving cell c.
```

### Section 8.2 of 3GPP TS 38.213

TABLE 8.2-2
TPC Command δ_{msg2, b, f, c} for PUSCH
The TPC command value δ_{msg2, b, f, c} is used for setting the power of the
PUSCH transmission, as described in Clause 7.1.1, and is interpreted
according to Table 8.2-2.

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

An Association Between DL Signal/Channel, and a Subset of RACH Resources and/or a Subset of Preamble Indices

### Section 8.1 in 3GPP TS 38.213

```
A UE is provided a number N of SS/PBCH block indexes associated with one PRACH occasion and a
number R of contention based preambles per SS/PBCH block index per valid PRACH occasion by ssb-
perRACH-OccasionAndCB-PreamblesPerSSB.
if N < 1, one SS/PBCH block index is mapped to 1/N consecutive valid PRACH occasions and R
contention based preambles with consecutive indexes associated with the SS/PBCH block index per
valid PRACH occasion start from preamble index 0. If N ≥ 1, R contention based preambles with
consecutive indexes associated with SS/PBCH block index n, 0 ≤ n ≤ N - 1, per valid PRACH
$occasion start from preamble index n \cdot {N}_{total}^{preamble} / N where {N}_{total}^{preamble} is provided by totalNumberOfRA -$
Preambles for Type-1 random access procedure.
SS/PBCH block indexes provided by ssb-PositionsInBurst in SIB1 or in ServingCellConfigCommon are
mapped to valid PRACH occasions in the following order where the parameters are described in [4, TS
38.211].
- First, in increasing order of preamble indexes within a single PRACH occasion
- Second, in increasing order of frequency resource indexes for frequency multiplexed PRACH
occasions
- Third, in increasing order of time resource indexes for time multiplexed PRACH occasions within a
PRACH slot
- Fourth, in increasing order of indexes for PRACH slots
An association period, starting from frame 0, for mapping SS/PBCH blocks to PRACH occasions is the
smallest value in the set determined by the PRACH configuration period according Table 8.1-1 such that
${N}_{T x}^{S S B} SS / PBCH blocks are mapped at least once to the PRACH occasions within the association period ,$
$where a UE obtains {N}_{T x}^{S S B} from the value of ssb - PositionsInBurst in SIB1 or in ServingCellConfigCommon .$
If after an integer number of SS/PBCH blocks to PRACH occasions mapping cycles within the association
$period there is a set of PRACH occasions or PRACH preambles that are not mapped to {N}_{Tx}^{SSB} SS / PBCH$
blocks, no SS/PBCH blocks are mapped to the set of PRACH occasions or PRACH preambles. An
association pattern period includes one or more association periods and is determined so that a pattern
between PRACH occasions and SS/PBCH blocks repeats at most every 160 msec. PRACH occasions
not associated with SS/PBCH blocks after an integer number of association periods, if any, are not used
for PRACH transmissions.
The PRACH occasions are mapped consecutively per corresponding SS/PBCH block index. The indexing
of the PRACH occasion indicated by the mask index value is reset per mapping cycle of consecutive
PRACH occasions per SS/PBCH block index. The UE selects for a PRACH transmission the PRACH
occasion indicated by PRACH mask index value for the indicated SS/PBCH block index in the first
available mapping cycle.
For the indicated preamble index, the ordering of the PRACH occasions is
      - First, in increasing order of frequency resource indexes for frequency multiplexed PRACH
    occasions
    - Second, in increasing order of time resource indexes for time multiplexed PRACH occasions
    within a PRACH slot
    - Third, in increasing order of indexes for PRACH slots
Table 8.1-1: Mapping between PRACH configuration period and SS/PBCH block to PRACH occasion
association period
```

| PRACH configuration period (msec) | Association period (number of PRACH configuration periods) |
|---|---|
| 10 | {1, 2, 4, 8, 16} |
| 20 | {1, 2, 4, 8} |
| 40 | {1, 2, 4} |
| 80 | {1, 2} |
| 160 | {1} |

### From 3GPP TS 38.331 V17.0.0

```
RACH-ConfigCommon IE
RACH-ConfigCommon ::= SEQUENCE {
  rach-ConfigGeneric RACH-ConfigGeneric,
  totalNumberOfRA-Preambles INTEGER (1..63) OPTIONAL, -- Need S
  ssb-perRACH-OccasionAndCB-PreamblesPerSSB CHOICE {
    oneEighth ENUMERATED {n4,n8,n12,n16,n20,n24,n28,n32,n36,n40,n44,n48,n52,n56,n60,n64},
    oneFourth ENUMERATED {n4,n8,n12,n16,n20,n24,n28,n32,n36,n40,n44,n48,n52,n56,n60,n64},
    oneHalf ENUMERATED {n4,n8,n12,n16,n20,n24,n28,n32,n36,n40,n44,n48,n52,n56,n60,n64},
    one ENUMERATED {n4,n8,n12,n16,n20,n24,n28,n32,n36,n40,n44,n48,n52,n56,n60,n64},
    two ENUMERATED {n4,n8,n12,n16,n20,n24,n28,n32},
    four INTEGER (1..16),
    eight INTEGER (1..8),
    sixteen INTEGER (1..4) } OPTIONAL, -- Need M
  groupBconfigured SEQUENCE {
    ra-Msg3SizeGroupA ENUMERATED {b56, b144, b208, b256, b282, b480, b640,
      b800, b1000, b72, spare6, spare5, spare4, spare3, spare2, spare1},
    messagePowerOffsetGroupB ENUMERATED { minusinfinity, dB0, dB5, dB8, dB10, dB12, dB15, dB18},
    numberOfRA-PreamblesGroupA INTEGER (1..64) } OPTIONAL, -- Need R
  ra-ContentionResolutionTimer ENUMERATED { sf8, sf16, sf24, sf32, sf40, sf48, sf56, sf64},
  rsrp-ThresholdSSB RSRP-Range OPTIONAL, -- Need R
  rsrp-ThresholdSSB-SUL RSRP-Range OPTIONAL, -- Cond SUL
  prach-RootSequenceIndex CHOICE {
    I839 INTEGER (0..837),
    I139 INTEGER (0..137) },
  msg1-SubcarrierSpacing SubcarrierSpacing OPTIONAL, -- Cond L139
  restrictedSetConfig ENUMERATED {unrestrictedSet, restrictedSetTypeA, restrictedSetTypeB},
  msg3-transformPrecoder ENUMERATED {enabled} OPTIONAL, -- Need R
  ...,
  [[
  ra-PrioritizationForAccessIdentity-r16 SEQUENCE {
        ra-Prioritization-r16 RA-Prioritization,
          ra-PrioritizationForAI-r16 BIT STRING (SIZE (2)) } OPTIONAL, -- Cond InitialBWP-Only
  prach-RootSequenceIndex-r16 CHOICE {
    I571 INTEGER (0..569),
    I1151 INTEGER (0..1149) } OPTIONAL -- Need R
  ]],
  ]]
  ra-PrioritizationForSlicing-r17 RA-PrioritizationForSlicing-r17 OPTIONAL, -- Cond InitialBWP-Only
  featureCombinationPreambles-r17 SEQUENCE (SIZE(1..maxFeatureCombPreambles-FFS-r17)) OF
  FeatureCombinationPreambles-r17 OPTIONAL -- Need R
  ] ]
ServingCellConfigCommon IE
  ServingCellConfigCommon ::= SEQUENCE {
    shortBitmap BIT STRING (SIZE (4)),
    mediumBitmap BIT STRING (SIZE (8)),
    longBitmap BIT STRING (SIZE (64)) } OPTIONAL, -- Cond AbsFreqSSB
  ssb-periodicityServingCell ENUMERATED { ms5, ms10, ms20, ms40, ms80, ms160, spare2, spare1 } OPTIONAL, -- Need
S
```

### RAR

### Section 8.2 in 3GPP TS 38.213 v17.1.0

TABLE 8.2-2
TPC Command δ_{msg2, b, f, c} for PUSCH
In response to a PRACH transmission, a UE attempts to detect
a DCI format 1_0 with CRC scrambled by a corresponding
RA-RNTI during a window controlled by higher layers [11, TS
38.321]. The window starts at the first symbol of
the earliest CORESET the UE is configured to receive
PDCCH for Type1-PDCCH CSS set, as defined in Clause 10.1,
that is at least one symbol, after the last symbol of
the PRACH occasion corresponding to the PRACH transmission,
where the symbol duration corresponds to the SCS for
Type1-PDCCH CSS set as defined in Clause 10.1. The length
of the window in number of slots, based on the SCS
for Type1-PDCCH CSS set, is provided by ra-ResponseWindow.
The TPC command value δ_{msg2b, f, c} is used for
setting the power of the PUSCH transmission, as described
in Clause 7.1.1, and is interpreted according to Table 8.2-2.
The CSI request field is reserved.

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

### Section 7.1.1

- If the UE receives a random access response message in response to a PRACH transmission on active UL
BWP b of carrier f of serving cell c as described in Clause 8

| | |
|---|---|
| - | f_{b,f,c}(0, l) = ΔP_{rampup,b,f,c} + δ_{msg2,b,f,c} , where l = 0 and |
| - | δ_{msg2,b,f,c} is a TPC command value indicated in the random access response grant of the random |

```
    access response message corresponding to the PRACH transmission on active UL BWP b of carrier
    f in the serving cell c , and
```

### SSB Selection in MAC

### In 3GPP TS 38.321

RRC configures the following parameters for the Random Access procedure:

| | |
|---|---|
| - | prach-ConfigurationIndex: the available set of PRACH occasions for the transmission of the Random |

Access Preamble;

| | |
|---|---|
| - | preambleReceivedTargetPower: initial Random Access Preamble power; |
| - | rsrp-ThresholdSSB: an RSRP threshold for the selection of the SSB. If the Random Access procedure is |

```
  initiated for beam failure recovery, rsrp-ThresholdSSB used for the selection of the SSB within
  candidateBeamRSList refers to rsrp-ThresholdSSB in BeamFailureRecoveryConfig IE;
```

| | |
|---|---|
| - | rsrp-ThresholdCSI-RS: an RSRP threshold for the selection of CSI-RS. If the Random Access procedure is |

```
  initiated for beam failure recovery, rsrp-ThresholdCSI-RS is equal to rsrp-ThresholdSSB in
  BeamFailureRecoveryConfig IE;
```

| | |
|---|---|
| - | rsrp-ThresholdSSB-SUL: an RSRP threshold for the selection between the NUL carrier and the SUL carrier; |
| - | candidateBeamRSList: a list of reference signals (CSI-RS and/or SSB) identifying the candidate beams for |

recovery and the associated Random Access parameters;

| | |
|---|---|
| - | recoverySearchSpaceId: the search space identity for monitoring the response of the beam failure recovery |

request;

| | |
|---|---|
| - | powerRampingStep: the power-ramping factor; |
| - | powerRampingStepHighPriority: the power-ramping factor in case of prioritized Random Access |

procedure;

| | |
|---|---|
| - | scalingFactorBI: a scaling factor for prioritized Random Access procedure; |
| - | ra-PreambleIndex: Random Access Preamble; |
| - | ra-ssb-OccasionMaskIndex: defines PRACH occasion(s) associated with an SSB in which the MAC entity |

may transmit a Random Access Preamble (see clause 7.4);

| | |
|---|---|
| - | ra-OccasionList: defines PRACH occasion(s) associated with a CSI-RS in which the MAC entity may |

transmit a Random Access Preamble;

| | |
|---|---|
| - | ra-PreambleStartIndex: the starting index of Random Access Preamble(s) for on-demand SI request; |
| - | preambleTransMax: the maximum number of Random Access Preamble transmission; |
| - | ssb-perRACH-OccasionAndCB-PreamblesPerSSB: defines the number of SSBs mapped to each PRACH |

occasion and the number of contention-based Random Access Preambles mapped to each SSB;

| | |
|---|---|
| - | if groupBconfigured is configured, then Random Access Preambles group B is configured. |
| - | Amongst the contention-based Random Access Preambles associated with an SSB (as defined in TS 38.213 |

```
    [6]), the first numberOfRA-PreamblesGroupA Random Access Preambles belong to Random Access
    Preambles group A. The remaining Random Access Preambles associated with the SSB belong to Random
    Access Preambles group B (if configured).
  NOTE 2: If Random Access Preambles group B is supported by the cell Random Access Preambles group B
  is included for each SSB.
```

### Contention-Free Random Access

As mentioned above, Contention Free Random Access (CFRA) is different from CBRA in that there is no contention in the Msg1 resources. This is ensured by assigning the UE with a specific preamble. Since there is no contention, the random access procedure can be made more simple, for instance ending the random access procedure once Msg2 (RAR) has been received. Since technically the random access procedure has ended, the Msg3 is usually termed PUSCH scheduled by RAR. This also means that there is no Msg4.

CFRA can be configured in the following cases:
Handovers/reconfiguration with sync;
Beam Failure Recovery;
PDCCH-ordered random access;
Establishment of secondary cell in Carrier aggregation.

In NR Rel-15, multiple PRACH transmissions was discussed for CFRA with some agreements, but it was not specified in the end.

### Agreements:

For contention-free random access, the following options are under evaluation
Option 1: Transmission of only a single Msg.1 before the end of a monitored RAR window
Option 2: A UE can be configured to transmit multiple simultaneous Msg.1
   Note: multiple simultaneous Msg.1 transmissions use different frequency resources and/or use the same frequency resource with different preamble indices
Option 3: A UE can be configured to transmit multiple Msg.1 over multiple RACH transmission occasions in the time domain before the end of a monitored RAR window

### Agreements:

For contention free case, a UE can be configured to transmit multiple Msg.1 over dedicated multiple RACH transmission occasions in time domain before the end of a monitored RAR window if the configuration of dedicated multiple RACH transmission occasions in time domain is supported.

Note: The time resource used for ‘dedicated RACH in time domain’ is different from the time resources of contention based random access

Note: Multiple Msg1 can be transmitted with same or different UE TX beams

### PDCCH Order

The random access procedure can be triggered by DL data arrival during RRC_CONNECTED when UE UL synchronisation status is “non-synchronised” through a PDCCH order. A gNB can estimate a UE's UL synchronization state by for instance when the last UL transmission from the UE happens. This is used for establishing synchronization for a secondary cell in Carrier Aggregation. In PDCCH-order the following fields can be indicated:

### 3GPP TS 38.212

- Random Access Preamble index - 6 bits according to ra-PreambleIndex in Clause 5.1.2 of [8, TS38.321]
- UL/SUL indicator - 1 bit. If the value of the “Random Access Preamble index” is not all zeros and if the UE is
configured with supplementaryUplink in ServingCellConfig in the cell, this field indicates which UL carrier in the cell to
transmit the PRACH according to Table 7.3.1.1.1-1; otherwise, this field is reserved
- SS/PBCH index - 6 bits. If the value of the “Random Access Preamble index” is not all zeros, this field indicates the
SS/PBCH that shall be used to determine the RACH occasion for the PRACH transmission; otherwise, this field is reserved.
- PRACH Mask index - 4 bits. If the value of the “Random Access Preamble index” is not all zeros, this field indicates
the RACH occasion associated with the SS/PBCH indicated by “SS/PBCH index” for the PRACH transmission, according to
Clause 5.1.1 of [8, TS38.321]; otherwise, this field is reserved
- Reserved bits - 12 bits for operation in a cell with shared spectrum channel access in frequency range 1 or when the
DCI format is monitored in common search space for operation in a cell in frequency range 2-2; otherwise 10 bits

### 3GPP TS 38.212

### NR Rel-17 Coverage Enhancements—Msg3 Repetitions

During the Rel-17 Coverage Enhancement Study Item, it was seen that the channel during the random access procedure to have the worst coverage is the PUSCH Msg3. Thus to improve the coverage of the random access procedure it was agreed that msg3 repetitions should be introduced.

The Msg3 repetitions work by the UE signaling that it needs Msg3 repetitions. It does this by comparing the RSRP of the cell it is connecting to with an RSRP threshold (rsrp-ThresholdMsg3). If the RSRP is below the threshold, the UE will select a specific PRACH or preamble resource to announce to the network that Msg3 repetitions have been requested. The network then receives specific preamble indicating Msg3 repetitions. Knowing that the UE has requested Msg3 repetitions the network schedules the amount of Msg3 repetitions through the RAR. The RAR has been re-purposed specifically for Msg3 repetitions and will indicate the number of Msg3 repetitions to perform.

### RACH Indication and Partitioning

As many features in rel-17 wanted to utilize msg1 preambles to indicate early on the existence of certain features such as Msg3 repetitions, redcap, slicing and Short Data Transmissions. The solution was to introduce a common framework for allocating preambles in ROs and conditions for using these preambles groups as well as the combination of different features, such as Msg3 repetitions and Redcap. With this framework, it is possible to for instance define an RO #1 with a preamble group indicating Redcap and Msg3 repetitions, and then an RO #2 with a preamble group defining Short Data transmissions and Redcap+Msg3 Repetitions. The conditions to use these preamble groups are then defined.

TABLE 1
Rel-17 UE behaviour in terms of Msg3 repetition

| | | RSRP < rsrp- | RSRP ≥ rsrp- |
|---|---|---|---|
| Rel-17 Msg3 repetition | | ThresholdMsg3 | ThresholdMsg3 |
| UE capable of Msg3 | PRACH preamble | R17 CE preamble | R15 preamble |
| repetition | interpretation of RAR | Rel-17 repurposed | Rel-15 way |
| | | way | |

As summarized in Table 1, with Rel-17 Msg3 repetitions for CBRA, a UE capable of Msg3 repetition will autonomously select PRACH resources to indicate that Msg3 repetitions are needed. This selection is done via a configured RSRP threshold, rsrp-ThresholdMsg3, where if the RSRP with the selected cell is below a threshold, the UE will select the configured PRACH resource to indicate msg3 repetitions. How to interpret RAR, either as indicating msg3 repetitions or as legacy RAR, is thus decided whether the UE has selected PRACH resources indicating msg3 repetitions or not. In the international patent application, “PCT/CN2021/108220”, methods for performing Msg3 repetitions in contention free random access was introduced. One of these methods dealt with the problem in CFRA versus CBRA. In CFRA it would be wasteful for the network to give multiple PRACH resource, thus in the present disclosure, it is suggested that the network configures a flag in the CFRA configuration that decides how the UE shall interpret the RAR, which decides whether msg3 repetitions should be performed or not. In some embodiments of the present disclosure, the flag could be reused for a UE to determine whether it should transmit one or multiple PRACH transmissions.

When introducing multiple PRACH transmissions in Rel-18, there are many issues as to how to configure this for CFRA. One issue is how to both signal multiple PRACH and msg3 repetitions in CFRA.

UE determination of single or multiple PRACH transmissions can reuse the Rel-17 threshold for Msg3 repetition. This can simplify UE determination of preamble. Nevertheless, there are still many things are to be sorted out, as listed in Table 2 below. For example, if gNB configures preambles specific for multiple PRACH transmissions, how can it tell if a UE is capable of Msg3 repetition or not. It matters how gNB encodes RAR. If a UE may have separate capabilities of Msg1 and Msg3 enhancements, further preamble partitioning can support the early indication of combinations of UE capabilities, but it increases signalling overhead.

TABLE 2
UE behaviours with different capabilities
of Rel-17 and Rel-18 coverage enhancement

| Rel-17 Msg3 repetition, Rel-18 | | RSRP < rsrp- | RSRP ≥ rsrp- |
|---|---|---|---|
| multiple PRACH transmissions | | ThresholdMsg3 | ThresholdMsg3 |
| UE capable of | PRACH preamble | R17 CE | R15 preamble |
| Msg3 repetition, | | preamble | |
| incapable of | interpretation of | Rel-17 | Rel-15 way |
| multiple PRACH | RAR | repurposed way | |
| transmissions | | | |
| UE capable of | PRACH preamble | R18 CE | R15 preamble |
| multiple PRACH | | preamble | |
| transmissions, | interpretation of | ? | Rel-15 way |
| incapable of Msg3 | RAR | | |
| repetition | | | |
| UE capable of both | PRACH preamble | R18 CE | R15 preamble |
| Msg3 repetition and | | preamble | |
| multiple PRACH | interpretation of | ? | Rel-15 way |
| transmissions | RAR | | |

Therefore, in some embodiments, several methods to signal the configuration for a UE to make access via repetitions on the PRACH with CFRA and/or CBRA are proposed. Further, in some embodiments, methods for switching from legacy random access on the PRACH to random access with multiple repetitions are proposed. Some embodiments of the present disclosure also cover methods on when a UE should interpret RAR in Rel-17 repurposed way assuming Msg3 repetition based on CFRA and/or CBRA PRACH configuration.

In some embodiments, a way for the network to communicate and distribute CFRA preambles and number of repetitions is provided. In some embodiments, a way for performing switching from legacy access to repetition based access is provided. With some embodiments of the present disclosure, a number of methods to communicate CFRA related parameters could be proposed and hopefully be taken into the applicable standards.

In Rel-18 Further NR Coverage Enhancements WI, one objective is to support multiple PRACH transmissions.
Specify following PRACH coverage enhancements (RAN1, RAN2)
   Multiple PRACH transmissions with same beams for 4-step RACH procedure
   Study, and if justified, specify PRACH transmissions with different beams for 4-step RACH procedure
   Note 1: The enhancements of PRACH are targeting for FR2, and can also apply to FR1 when applicable.
   Note 2: The enhancements of PRACH are targeting short PRACH formats, and can also apply to other formats when applicable.

There are several scenarios of multiple PRACH transmissions in terms of beam and SSB. Scenario 1 is a UE transmits multiple PRACH with the same beam, and all the PRACH transmissions are associated with the same SSB. Scenario 2 is that the different beams are used for PRACH transmissions and associated with one SSB. The determination of UL Tx beams is up to UE implementation and is transparent to gNB. Scenario 3-1 and Scenario 3-2 are related to that the multiple PRACH transmissions are associated with different SSB beams. In Scenario 3-1, there is only one PRACH associated with each selected SSB, while in Scenario 3-2, at least one SSB is associated with more than one PRACH transmission. Scenario 3-2 is a combination of Scenario 3-1 and Scenario 2 and can use the solutions of both scenarios. Therefore, in some embodiments of the present disclosure, the first two scenarios may be discussed.

In some embodiments, PRACH and Msg1 transmission may both refer to transmitting a preamble as part of the random access procedure. In some embodiments, PRACH resource can be the PRACH time frequency resource of the PRACH preamble.

### Signalling and Configuring of Multiple PRACH Transmissions for CFRA

In NR Rel-18, for CBRA, it is envisioned that a UE may determine single PRACH transmission or multiple PRACH transmissions (including the number of PRACH transmissions) based on RSRP measurement of the selected SSB. In the case of CFRA for example for handover, the target gNB determines if a UE should perform a single PRACH transmission or multiple PRACH transmissions, e.g., based on UE measurement report of the target cell and then source gNB signals the decision to the UE. Other problems are how to signal the number of multiple PRACH transmissions and corresponding resources, whether a UE should interpret RAR in Rel-17 repurposed way assuming Msg3 repetition.

In some embodiments, the number(s) of PRACH transmissions may be signalled in the CFRA configuration. In some embodiments, let K denote the number of PRACH transmissions. In some embodiments, potentially more than one candidate values of K could be indicated in CFRA configuration, and the UE can determine one of them based on the RSRP measurement when RA is performed, otherwise the UE may transmit PRACH the indicated K times.

In some embodiments, the number of PRACH transmissions may be communicated to the UE by parameters that are used to indicate CFRA multiple preamble values, for instance through new SSB RSRP thresholds or offsets. In some embodiments, the smallest candidate value may indicate single PRACH transmission. In some embodiments, larger offset value may mean a larger number of PRACH transmissions.

In some embodiments, to configure multiple PRACH transmission, the UE may be only configured with a specific preamble, whose index is relative to that of the first preamble for the selected SSB in the RO. However, the PRACH resource could be associated with a CFRA configuration with a specific number of PRACH transmission, and the UE will perform the number of PRACH transmissions that is implied by the configuration. This makes it implicit whether UE should perform PRACH repetitions, but CFRA configuration can remain the same. In some embodiments, the CFRA configuration can include the mapping between the PRACH preamble index and the number of PRACH transmissions. This also makes sense as CBRA configurations would be configured through the RACH indication and partitioning framework. Alternatively, in some embodiments, the UE can be configured with an identifier pointing to a resource within the RACH indication and partitioning configuration framework.

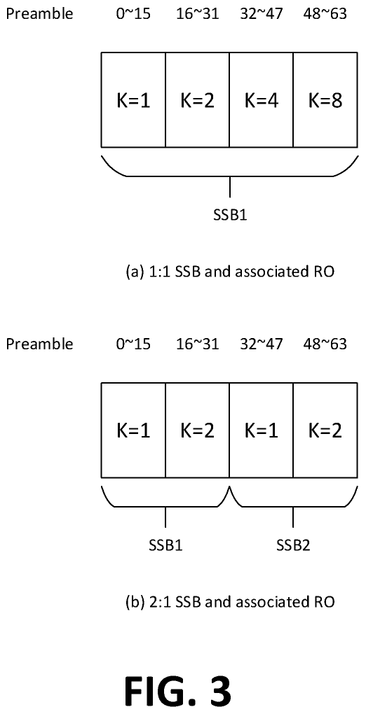

FIG. 3 shows an example of 1:1 mapping between SSB and RO in (a) and an example of 2:1 mapping between SSB and RO in (b). As shown in (a) of FIG. 3, the 64 preambles with indices from 0 to 63 in a RO may be divided into four groups for 1, 2, 4 and 8 PRACH transmissions, respectively. Preambles with indices from 0 to 15 may be used for single PRACH transmission. The same number of indices may be dedicated to the other preamble groups. For example, if a UE is indicated preamble index #31, it will transmit two PRACHs. As shown in (b) of FIG. 3, in the case of two SSBs associated with one RO, the index UE is configured with may be a relative index to the index of starting preamble for the SSB in the RO. As illustrated in (b) of FIG. 3, two preamble groups with different K values may be configured for each SSB. Given the UE indicated preamble index #31, if SSB1 is selected, the UE may transmit preamble #31 twice, and if SSB2 is selected, preamble #63 may be transmitted twice.

### 2-Step RACH Procedure

In some embodiments, the multiple PRACH transmission may be signalled for 4-step random access and 2-step random access individually. For 2-step random access, it would be called MsgA PRACH repetitions.

In some embodiments, if only one of the number of MsgA PRACH transmissions and the number of MsgA PUSCH transmissions is indicated in a CFRA signalling, the UE can derive the other one by assuming that MsgA PRACH and MsgA PUSCH are of the same coverage enhancement level.

In some embodiments, gNB may configure in SIB1 the 2-step RACH parameters related to coverage enhancement, including the candidate numbers for multiple MsgA PRACH transmissions and those for repetitions of MsgA PUSCH. The same number sets also apply to CFRA.

For example, as configured in SIB1, the candidate numbers of PRACH transmissions may include 1, x₁, x₂, . . . , x_{N} in increasing order, and those for MsgA PUSCH transmissions may be 1, y₁, y₂, . . . , y_{N} also in increasing order. The same coverage enhancement level may mean the same index of the number is used for both channels. For example, if xₙ is indicated in CFRA signaling, the UE can derive yₙ. If the values with the same index are equal, i.e., xₙ=yₙ, MsgA PRACH and MsgA PUSCH will have the same number of transmissions.

In some embodiments, switching from legacy 2-step RA to 2-step RA with multiple PRACH transmissions is introduced. The latter means multiple MsgA PRACH transmissions are adopted for retransmission, when the single PRACH transmission for MsgA PRACH initial transmission fails. The legacy 2-step RA without multiple PRACH transmissions and 2-step RA with multiple PRACH transmissions can use same or similar MsgA PUSCH resources or they can be different, up to gNB configuration of RO and preamble for a specific number of PRACH transmissions. This for instance allows for the possibility of attempting fast CFRA through legacy 2-step RA but having a more reliable 2-step RACH with multiple PRACH transmissions in case the radio conditions are not as good as expected.

### CFRA RACH Procedure Triggered by PDCCH Order

In some embodiments, for PDCCH order a UE can be indicated the number of PRACH transmissions and/or PRACH resources for CFRA and initiates RACH procedure if needed. This can be signalled either for 4-step or 2-step RA. In some embodiments, a flag in the PDCCH-order may indicate whether the UE shall initiate multiple PRACH transmissions. Then the action of the UE is to determine the number of PRACH transmissions, if needed and find resources for multiple PRACH transmissions. If gNB configures more than one candidate numbers of PRACH transmission and does not indicate a specific one to the UE, the UE needs to determine one of them. Otherwise, the flag may definitely indicate the number of PRACH transmission.

### CFRA RACH Procedure Triggered by BFR

In some embodiments, multiple PRACH transmissions for Beam Failure Recovery (BFR) may be enabled. This can be made configurable specifically for BFR. This can be done either through a flag that indicates that multiple PRACH transmissions should be performed, or the configuration can give the number of PRACH transmissions K, or alternatively a specific PRACH configuration for multiple PRACH transmissions.

Since CFRA Beam Failure Recovery uses a timer beamFailureRecovery Timer that determines how long a UE may perform CFRA BFR, with multiple PRACH transmissions it may be that it can take longer to do BFR compared to single PRACH transmission. For this reason, a timer specifically for the case of multiple PRACH transmissions is introduced. This can be extended or an infinity value can be included. The reason for extended value is that if it takes longer than a new maximum value may be needed. The infinity value, which would indirectly allow UE to continue CFRA BFR until maximum attempts have been tried, can be provided because the coverage of CFRA BFR can be better than the alternatives where multiple PRACH transmissions may not be configured. This can for instance be beneficial if a network does not want to utilize coverage enhancements in CBRA to ensure that only UEs with good connection attempt to attach to the cell, but network still wants to retain good coverage once the UEs has attached.

### Signalling of Repetitions of PUSCH Scheduled by RAR

“PUSCH scheduled by RAR” is the term used in 3GPP specifications, including CBRA Msg3 transmission and CFRA PUSCH scheduled by RAR. For CFRA, the RACH process may be considered complete with the success receiving of RAR, so there is no Msg3. However, RAR can schedule a subsequent PUSCH transmission, which is called CFRA PUSCH scheduled by RAR. Repetition of CFRA PUSCH scheduled by RAR is not supported in Rel-17, but it is likely to be supported and configured together with CFRA PRACH repetition in Rel-18.

Msg3 usually have worse coverage compared to Msg1, which means that if multiple PRACH transmission is being performed, then Msg3 repetition should also be enabled. It is the same to CFRA PUSCH scheduled RAR. Both multiple PRACH transmission and Msg3 repetitions can be included in a single configuration called CE-CFRA (Coverage Enhancement CFRA) that enables better CFRA, and by extension also handover performance.

As Rel-17 Msg3 repetition relies on an early indication of UE capability by preamble, if multiple PRACH transmission also relies on preamble to indicate the number of PRACH transmissions, it would cause further and more complex PRACH partitioning among UEs supporting one of Msg3 repetitions and multiple PRACH transmissions and UEs supporting both.

In some embodiments, UE capability of multiple-PRACH-transmission may imply the UE capability of Msg3 repetition, and it may additionally imply the capability of repetition of CFRA PUSCH scheduled by RAR. In other words, one UE which supports multiple PRACH transmissions for CBRA and CFRA may also support repetition of PUSCH scheduled by RAR. This can solve the problem that for CBRA, a gNB cannot determine the UE's capability of Msg3 repetition, if the preamble only indicates UE's capability of multiple PRACH transmissions.

In some embodiments, for 2-step RACH, if a UE supports multiple MsgA PRACH transmissions, the UE may also support repetition of MsgA PUSCH.

### For CFRA

In some embodiments, given a UE's capability, if one or more of the following conditions occur, and the UE launches CFRA, it is implied that the UE would interpret RAR in the Rel-17 repurposed way, namely the repurposed MCS information field is applied. K denotes the number of CFRA PRACH transmissions. The conditions may include:
when CFRA resources for multiple PRACH transmissions with only K>1 are configured;
when CFRA resources for multiple PRACH transmissions with K≥1 are configured, regardless of single or multiple PRACH transmissions of the CFRA resources;
when CFRA resources for multiple PRACH transmissions with K≥1 are configured and the UE initiates multiple PRACH transmissions with K>1 using CFRA resources.

In some embodiments, the PDCCH order indicating multiple PRACH transmissions may also indicate that the UE shall interpret the RAR in the Rel-17 repurposed way, namely the repurposed MCS information field is applied.

### For CBRA

In one embodiment, given a UE's capability, if it initiates multiple PRACH transmissions for CBRA according to the selected SSB's RSRP, and Msg3 repetition is configured in SIB1, the UE should interpret RAR in Rel-17 repurposed way, namely the repurposed MCS information field is applied.

With some embodiments of the present disclosure, a UE may be appropriately configured by a RAN node for CE CFRA and/or CE CBRA, such that CE features, such as multiple PRACH transmissions and/or PUSCH transmissions scheduled by RAR with repetitions, can be correctly applied during the random access. In this way, a higher chance of successful access may be achieved with reduced signalling overhead.

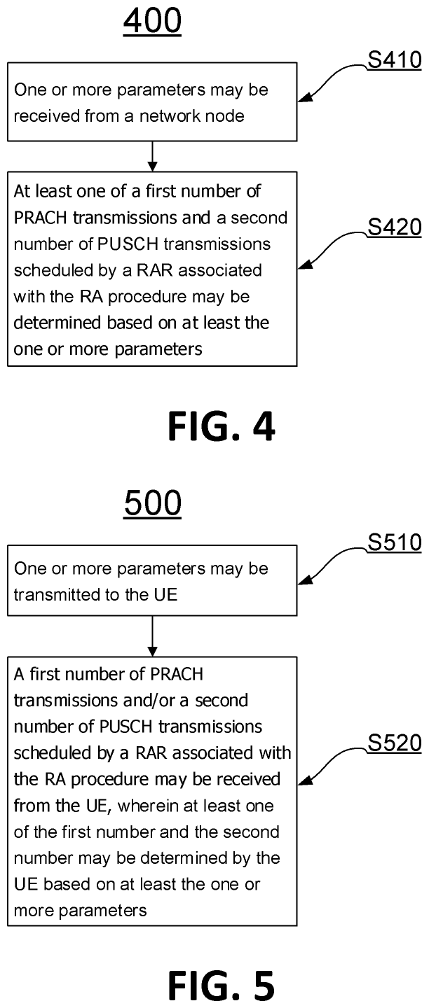

FIG. 4 is a flow chart of an exemplary method 400 at a UE for performing an RA procedure according to an embodiment of the present disclosure. The method 400 may be performed at a user equipment (e.g., the UE 100). The method 400 may comprise steps S410 and S420. However, the present disclosure is not limited thereto. In some other embodiments, the method 400 may comprise more steps, less steps, different steps, or any combination thereof. Further the steps of the method 400 may be performed in a different order than that described herein when multiple steps are involved. Further, in some embodiments, a step in the method 400 may be split into multiple sub-steps and performed by different entities, and/or multiple steps in the method 400 may be combined into a single step.

The method 400 may begin at step S410 where one or more parameters may be received from a network node.

At step S420, at least one of a first number of PRACH transmissions, a second number of PUSCH transmissions scheduled by a RAR associated with the RA procedure, and a third number of MsgA PUSCH transmissions may be determined based on at least the one or more parameters.

In some embodiments, the method 400 may further comprise at least one of: performing the first number of PRACH transmissions; performing the second number of PUSCH transmissions scheduled by the RAR; and performing the third number of MsgA PUSCH transmissions. In some embodiments, the one or more parameters may comprise at least one of: one or more first candidate numbers of PRACH transmissions; one or more second candidate numbers of PUSCH transmissions scheduled by the RAR associated with the RA procedure; one or more third candidate numbers of MsgA PUSCH transmissions; a preamble index; and an identifier indicating a resource within a RACH indication and partitioning configuration framework.

In some embodiments, when the one or more parameters comprise a single first candidate number, the step of determining the first number may comprise: determining the single first candidate number as the first number. In some embodiments, when the one or more parameters comprise multiple first candidate numbers, the step of determining the first number may comprise: determining one of the multiple first candidate numbers as the first number based on at least RSRP measured for a selected SSB. In some embodiments, the one or more parameters may further comprise at least one of: one or more offsets to a first threshold, the first threshold being used in determining whether the RA procedure without CE is to fall back from a CFRA procedure to a CBRA procedure; one or more second thresholds, each of which is used in determining whether the CFRA procedure is to fall back, at a corresponding CE level, from a CFRA procedure to a CBRA procedure; and a flag indicating that no fallback from a CFRA procedure to a CBRA procedure is allowed.

In some embodiments, when the one or more parameters comprise the one or more offsets, multiple ranges may be defined by the one or more offsets and the first threshold and at least one of the multiple ranges, Rᵢ, may be defined as follows:

$${R}_{i} = \{ \begin{matrix}( the first threshold , + ∞ ) , & if i = 1 \\ ( the first threshold - & if i = 2 \\ {\sum }_{k = 1}^{i - 1} {offset}_{k} , the first threshold ] , & \\ ( the first threshold - {\sum }_{k = 1}^{i - 1} {offset}_{k} , & if 2 < i \leq N + 1 \\ the first threshold - {\sum }_{k = 1}^{i - 2} {offset}_{k} ] , & \end{matrix}$$

where offsetₖ is the k^{th} offset, and N is the number of the one or more offsets.

In some embodiments, when the one or more parameters comprise the one or more second thresholds, multiple ranges may be defined by the one or more second thresholds and the first threshold and at least one of the multiple ranges Rᵢ may be defined as follows:

$${R}_{i} = \{ \begin{matrix}( the first threshold , + ∞ ) , & if i = 1 \\ ( the {( i - 1 )}^{th} second threshold , & if i = 2 \\ the first threshold ] , & \\ ( the {( i - 1 )}^{th} second threshold , & if 2 < i \leq N + 1 \\ the {( i - 2 )}^{th} second threshold ] , & \end{matrix}$$

where N is the number of the one or more second thresholds.

In some embodiments, the step of determining the first number may comprise: determining one of the multiple ranges into which the RSRP measured for the selected SSB falls; and determining one of the multiple first candidate numbers associated with the determined range as the first number. In some embodiments, the first number may be determined to be 1 when the index of the determined range is 1. In some embodiments, the first number may be determined to be greater when the index of the determined range is greater.

In some embodiments, when the RA procedure is a Type 2 RA procedure, the step of determining the first number may comprise, after the third number is determined: determining, from the one or more first candidate numbers, a first candidate number that is associated with the determined third number as the first number. In some embodiments, when the RA procedure is a Type 2 RA procedure, the step of determining the third number may comprise, after the first number is determined: determining, from the one or more third candidate numbers, a third candidate number that is associated with the determined first number as the third number. In some embodiments, the one or more first candidate numbers may be ordered in an increasing order by their values and are indexed, the one or more third candidate numbers may be ordered in an increasing order by their values and are indexed, a first candidate number may be associated with a third candidate number when their indices are equal to each other. In some embodiments, the first number may be equal to the third number.

In some embodiments, when the one or more parameters comprise the preamble index, the step of determining the first number may comprise: determining a number associated with a preamble as the first number, wherein the preamble may be indicated by the preamble index and is to be transmitted in a RO associated with a selected SSB. In some embodiments, the one or more parameters may further comprise a mapping between the preamble index and the number associated with the preamble. In some embodiments, the preamble index may be an index relative to the first preamble associated with the selected SSB in the RO. In some embodiments, when the one or more parameters comprise the identifier, the step of determining the first number may comprise: determining a number associated with a resource as the first number, wherein the resource is indicated by the identifier and is used for at least one of the first number of PRACH transmissions.

In some embodiments, the one or more parameters may comprise at least one of: one or more first parameters for a Type 1 RA procedure; and one or more second parameters for a Type 2 RA procedure; and one or more third parameters for both a Type 1 RA procedure and a Type 2 RA procedure. In some embodiments, the step of determining at least one of the first number and the second number may comprise at least one of: determining at least one of the first number and the second number based on at least the one or more first parameters when the RA procedure is a Type 1 RA procedure; determining at least one of the first number, the second number, and the third number based on at least the one or more second parameters when the RA procedure is a Type 2 RA procedure; and determining at least one of the first number, the second number, and the third number based on at least the one or more third parameters no matter whether the RA procedure is a Type 1 RA procedure or a Type 2 RA procedure.

In some embodiments, when the RA procedure is a Type 2 RA procedure, the method 400 may further comprise: performing a single PRACH transmission as the initial MsgA PRACH transmission; and performing the first number of PRACH transmissions in response to determining that the initial MsgA PRACH transmission fails. In some embodiments, at least one of the one or more parameters may be provided in at least one of: a CFRA configuration; a PDCCH order; and a BFR configuration. In some embodiments, when the RA procedure is performed for BFR, the one or more parameters may further comprise a timer indicating how long the UE can perform the RA procedure, such that the first number of PRACH transmissions are expected to be completed before the timer expires.

In some embodiments, the RA procedure may be a CFRA procedure or a CBRA procedure. In some embodiments, when the UE supports multiple PRACH transmissions for Type-1 CFRA and/or Type-1 CBRA, the UE may also support repetition of PUSCH scheduled by RAR. In some embodiments, when the UE supports multiple PRACH transmissions for Type-2 CFRA and/or Type-2 CBRA, the UE may also support repetition of MsgA PUSCH. In some embodiments, the method 400 may further comprise: receiving, from the network node, a RAR; determining how to interpret the received RAR based on at least whether one or more conditions are met or not. In some embodiments, the step of determining how to interpret the received RAR may comprise at least one of: determining that the received RAR is to be interpreted in the Rel-17 repurposed way in response to determining that the one or more conditions are met; and determining that the received RAR is to be interpreted in the Rel-15 way in response to determining that the one or more conditions are not met. In some embodiments, when the received RAR is to be interpreted in the Rel-17 repurposed way, an MCS field in the received RAR may be interpreted in the Rel-17 repurposed way.

In some embodiments, when the RA procedure is a CFRA procedure, the one or more conditions may comprise at least one of: CFRA resources for multiple PRACH transmissions with only K>1 are configured; CFRA resources for multiple PRACH transmissions with K≥1 are configured, regardless of single or multiple PRACH transmissions of the CFRA resources; and CFRA resources for multiple PRACH transmissions with K≥1 are configured and the UE initiates multiple PRACH transmissions with K>1 using CFRA resources, where K is any of the one or more first candidate numbers.

In some embodiments, when the RA procedure is a CFRA procedure and when the CFRA procedure is triggered by a PDCCH order, the method 400 may further comprise: receiving, from the network node, a RAR; determining how to interpret the received RAR based on at least the PDCCH order. In some embodiments, the step of determining how to interpret the received RAR may comprise: determining that the received RAR is to be interpreted in the Rel-17 repurposed way when the PDCCH order indicates multiple PRACH transmissions; and determining that the received RAR is to be interpreted in the Rel-15 way when the PDDCH order does not indicate multiple PRACH transmissions. In some embodiments, when the received RAR is to be interpreted in the Rel-17 repurposed way, an MCS field in the received RAR may be interpreted in the Rel-17 repurposed way.

In some embodiments, when the RA procedure is a CBRA procedure, the method 400 may further comprise: receiving, from the network node, a RAR; determining how to interpret the received RAR based on at least one of: whether Msg3 repetition is configured in SIB1; and whether multiple PRACH transmissions are performed. In some embodiments, the step of determining how to interpret the received RAR may comprise at least one of: determining that the received RAR is to be interpreted in the Rel-17 repurposed way in response to determining that Msg3 repetition is configured in SIB1 and that multiple PRACH transmissions are performed; and determining that the received RAR is to be interpreted in the Rel-15 way in response to determining that Msg3 repetition is not configured in SIB1 and/or that multiple PRACH transmissions are not performed. In some embodiments, when the received RAR is to be interpreted in the Rel-17 repurposed way, an MCS field in the received RAR may be interpreted in the Rel-17 repurposed way.

FIG. 5 is a flow chart of an exemplary method 500 at a network node for performing an RA procedure with a UE according to an embodiment of the present disclosure. The method 500 may be performed at a network node (e.g., the gNB 105). The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step S510 where one or more parameters may be transmitted to the UE.

At step S520, at least one of a first number of PRACH transmissions, a second number of PUSCH transmissions scheduled by a RAR associated with the RA procedure, and a third number of MsgA PUSCH transmissions may be received from the UE. In some embodiments, at least one of the first number, the second number, and the third number may be determined by the UE based on at least the one or more parameters.

In some embodiments, the one or more parameters may comprise at least one of: one or more first candidate numbers of PRACH transmissions; one or more second candidate numbers of PUSCH transmissions scheduled by the RAR associated with the RA procedure; one or more third candidate numbers of MsgA PUSCH transmissions; a preamble index; an identifier indicating a resource within a RACH indication and partitioning configuration framework. In some embodiments, the one or more parameters may further comprise at least one of: one or more offsets to a first threshold, the first threshold being used in determining whether the RA procedure without CE is to fall back from a CFRA procedure to a CBRA procedure; one or more second thresholds, each of which is used in determining whether the CFRA procedure is to fall back, at a corresponding CE level, from a CFRA procedure to a CBRA procedure; and a flag indicating that no fallback from a CFRA procedure to a CBRA procedure is allowed.

In some embodiments, the one or more parameters may comprise at least one of: one or more first parameters for a Type 1 RA procedure; and one or more second parameters for a Type 2 RA procedure; and one or more third parameters for both a Type 1 RA procedure and a Type 2 RA procedure. In some embodiments, at least one of the one or more parameters may be provided in at least one of: a CFRA configuration; a PDCCH order; and a BFR configuration. In some embodiments, when the RA procedure is performed for BFR, the one or more parameters may further comprise a timer indicating how long the UE can perform the RA procedure, such that the first number of PRACH transmissions are expected to be completed before the timer expires.

In some embodiments, the RA procedure may be a CFRA procedure or a CBRA procedure. In some embodiments, the method 500 may further comprise: receiving, from the UE, a message indicating that the UE supports multiple PRACH transmissions for Type-1 CFRA and/or Type-1 CBRA; and determining that the UE also supports repetition of PUSCH scheduled by RAR based on at least the received message. In some embodiments, The method 500 may further comprise: receiving, from the UE, a message indicating that the UE supports multiple PRACH transmissions for Type-2 CFRA and/or Type-2 CBRA; and determining that the UE also supports repetition of MsgA PUSCH.

In some embodiments, the method 500 may further comprise at least one of: determining how a RAR is to be interpreted by the UE based on at least whether one or more conditions are met or not; generating the RAR based on at least the determination; and transmitting, to the UE, the generated RAR. In some embodiments, the step of determining how a RAR is to be interpreted by the UE may comprise at least one of: determining that the RAR is to be interpreted by the UE in the Rel-17 repurposed way in response to determining that the one or more conditions are met; and determining that the RAR is to be interpreted by the UE in the Rel-15 way in response to determining that the one or more conditions are not met. In some embodiments, when the RAR is to be interpreted by the UE in the Rel-17 repurposed way, an MCS field in the RAR may be generated such that it is to be interpreted by the UE in the Rel-17 repurposed way.

In some embodiments, when the RA procedure is a CFRA procedure, the one or more conditions may comprise at least one of: CFRA resources for multiple PRACH transmissions with only K>1 are configured for the UE; CFRA resources for multiple PRACH transmissions with K≥1 are configured for the UE, regardless of single or multiple PRACH transmissions of the CFRA resources; and CFRA resources for multiple PRACH transmissions with K≥1 are configured for the UE and the UE initiates multiple PRACH transmissions with K>1 using CFRA resources, where K is any of the one or more first candidate numbers.

In some embodiments, when the RA procedure is a CFRA procedure and when the CFRA procedure is triggered by a PDCCH order, the method 500 may further comprise at least one of: determining how a RAR is to be interpreted by the UE based on at least the PDCCH order; generating the RAR based on at least the determination; and transmitting, to the UE, the generated RAR. In some embodiments, the step of determining how a RAR is to be interpreted by the UE may comprise: determining that the RAR is to be interpreted by the UE in the Rel-17 repurposed way when the PDCCH order indicates multiple PRACH transmissions; and determining that the RAR is to be interpreted by the UE in the Rel-15 way when the PDDCH order does not indicate multiple PRACH transmissions. In some embodiments, when the RAR is to be interpreted by the UE in the Rel-17 repurposed way, an MCS field in the RAR may be generated such that it may be interpreted by the UE in the Rel-17 repurposed way.

In some embodiments, when the RA procedure is a CBRA procedure, the method 500 may further comprise at least one of: determining how a RAR is to be interpreted by the UE based on at least one of whether Msg3 repetition is configured in SIB1 and whether multiple PRACH transmissions are performed by the UE; generating the RAR based on at least the determination; and transmitting, to the UE, the generated RAR. In some embodiments, the step of determining how a RAR is to be interpreted by the UE may comprise at least one of: determining that the RAR is to be interpreted by the UE in the Rel-17 repurposed way in response to determining that Msg3 repetition is configured in SIB1 and that multiple PRACH transmissions are performed; and determining that the RAR is to be interpreted by the UE in the Rel-15 way in response to determining that Msg3 repetition is not configured in SIB1 and/or that multiple PRACH transmissions are not performed. In some embodiments, when the RAR is to be interpreted by the UE in the Rel-17 repurposed way, an MCS field in the RAR may be generated such that it may be interpreted by the UE in the Rel-17 repurposed way.

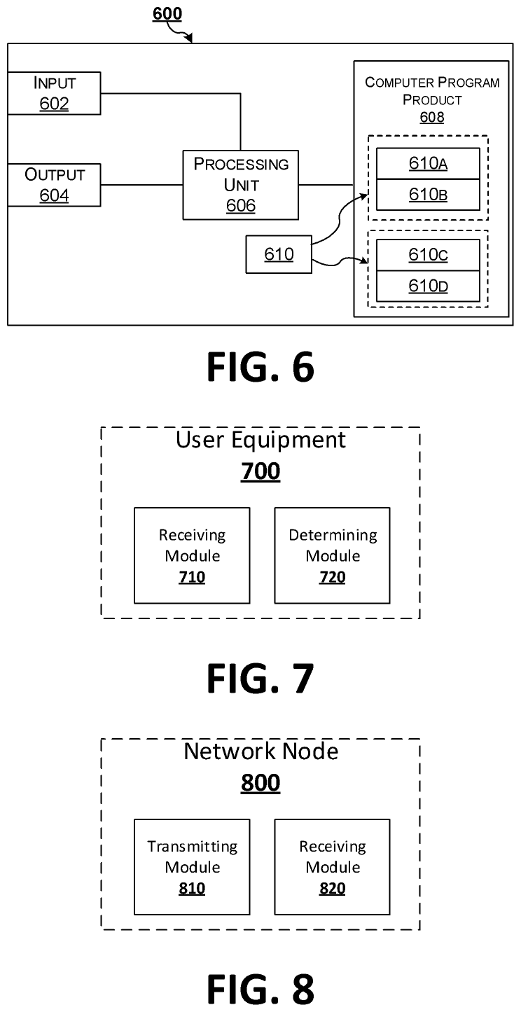

FIG. 6 schematically shows an embodiment of an arrangement 600 which may be used in a user equipment (e.g., the UE 100) or a network node (e.g., the gNB 105) according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the UE/network node in which it is comprised to perform the actions, e.g., of the procedure described earlier in conjunction with FIG. 2 through FIG. 5 or any other variant.

The computer program 610 may be configured as a computer program code structured in computer program modules 610A and 610B. Hence, in an exemplifying embodiment when the arrangement 600 is used in a UE, the code in the computer program of the arrangement 600 includes: a module 610A configured to receive, from a network node, one or more parameters; and a module 610B configured to determine, based on at least the one or more parameters, at least one of: a first number of PRACH transmissions; a second number of PUSCH transmissions scheduled by a RAR associated with the RA procedure; and a third number of MsgA PUSCH transmissions.

Further, the computer program 610 may be further configured as a computer program code structured in computer program modules 610C and 610D. Hence, in an exemplifying embodiment when the arrangement 600 is used in a network node, the code in the computer program of the arrangement 600 includes: a module 610C configured to transmit, to the UE, one or more parameters; and a module 610D configured to receive, from the UE, at least one of: a first number of PRACH transmissions; a second number of PUSCH transmissions scheduled by a RAR associated with the RA procedure; and a third number of MsgA PUSCH transmissions, wherein at least one of the first number, the second number, and the third number is determined by the UE based on at least the one or more parameters.

The computer program modules could essentially perform the actions of the flow illustrated in FIG. 2 through FIG. 5, to emulate the UE or the network node. In other words, when the different computer program modules are executed in the processing unit 606, they may correspond to different modules in the UE or the network node.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

Correspondingly to the method 400 as described above, an exemplary user equipment is provided. FIG. 7 is a block diagram of a UE 700 according to an embodiment of the present disclosure. The UE 700 may be, e.g., the UE 100 in some embodiments.

The UE 700 may be configured to perform the method 400 as described above in connection with FIG. 4. As shown in FIG. 7, the UE 700 may comprise: a receiving module 710 configured to receive, from a network node, one or more parameters; and a determining module 720 configured to determine, based on at least the one or more parameters, at least one of: a first number of PRACH transmissions; a second number of PUSCH transmissions scheduled by a RAR associated with the RA procedure; and a third number of MsgA PUSCH transmissions.

The above modules 710 and/or 720 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4. Further, the UE 700 may comprise one or more further modules, each of which may perform any of the steps of the method 400 described with reference to FIG. 4.

Correspondingly to the method 500 as described above, a network node is provided. FIG. 8 is a block diagram of an exemplary network node 800 according to an embodiment of the present disclosure. The network node 800 may be, e.g., the gNB 105 in some embodiments.

The network node 800 may be configured to perform the method 500 as described above in connection with FIG. 5. As shown in FIG. 8, the network node 800 may comprise a transmitting module 810 configured to transmit, to the UE, one or more parameters; and a receiving module 820 configured to receive, from the UE, at least one of: a first number of PRACH transmissions; a second number of PUSCH transmissions scheduled by a RAR associated with the RA procedure; and a third number of MsgA PUSCH transmissions, wherein at least one of the first number, the second number, and the third number is determined by the UE based on at least the one or more parameters.

The above modules 810 and 820 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 5. Further, the network node 800 may comprise one or more further modules, each of which may perform any of the steps of the method 500 described with reference to FIG. 5.

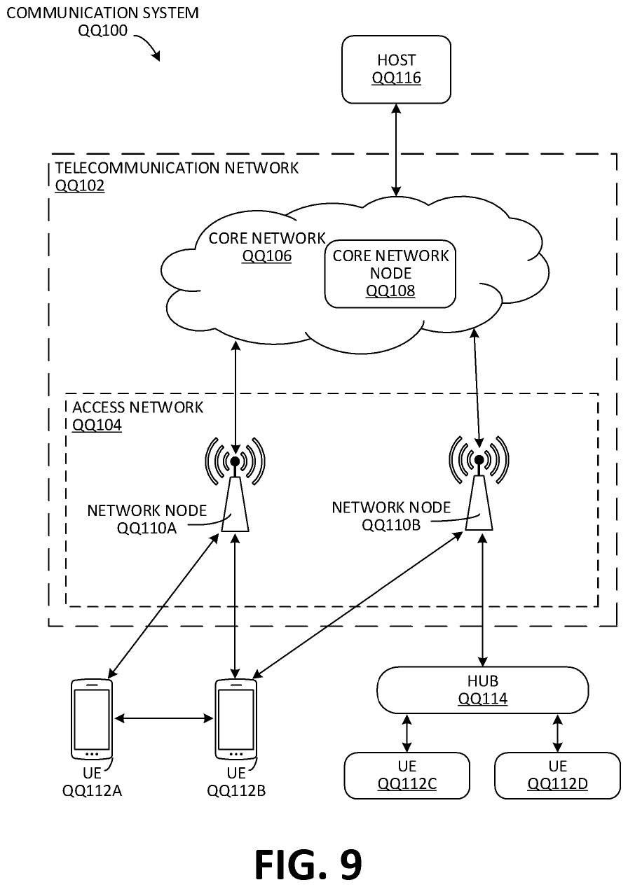

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

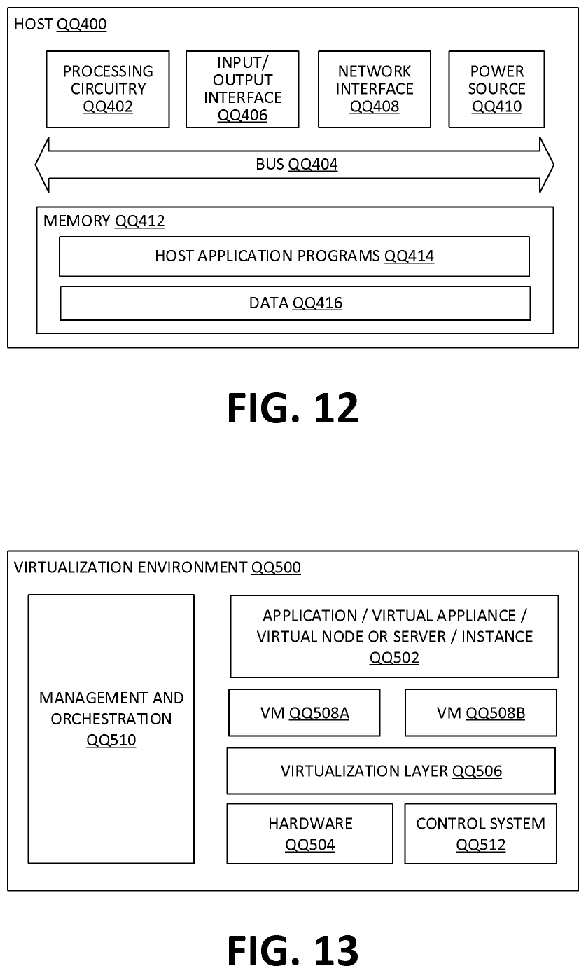

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 10 and FIG. 11, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

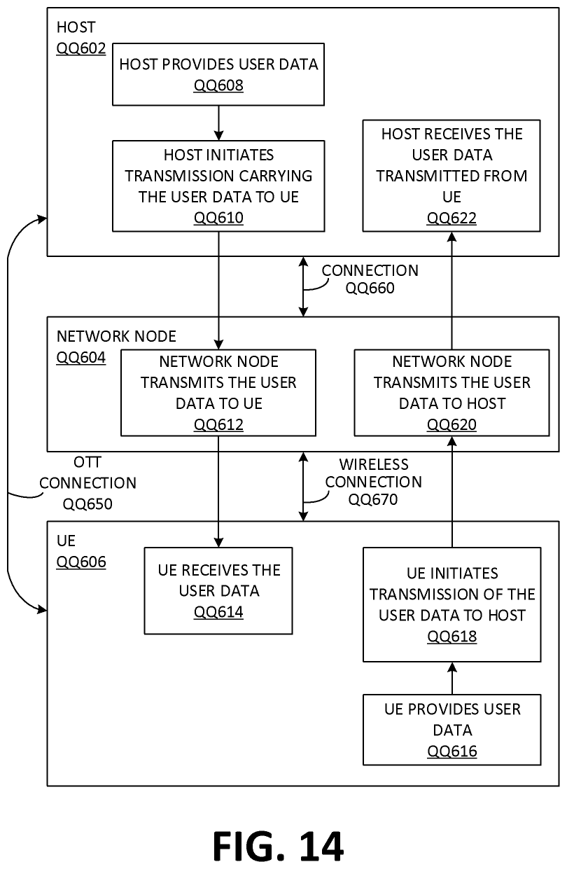

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9 and/or UE QQ200 of FIG. 10), network node (such as network node QQ110a of FIG. 9 and/or network node QQ300 of FIG. 11), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

### Abbreviation Explanation

BFR Beam Failure Recovery
CBRA Contention Based Random Access
CFRA Contention Free Random Access
CSI-RS Channel State Information Reference Signal
DL Downlink
LTE-M LTE Machine type communications
MAC Medium Access Control
NB-IoT Narrowband IoT
PBCH Physical Broadcast Channel
PDCCH Physical Downlink Control Channel
PRACH Physical random access channel
PUSCH Physical Uplink Shared Channel
RAPID Random Access Preamble Identity
RAR Random Access Response
RO (P) RACH occasion or (P) RACH transmission occasion
RSRP Reference Signal Received Power
SDT Short Data Transmissions
SSB Synchronization Signal Block
TPC Transmit Power Control

1. A method at a User Equipment for performing a random access (RA) procedure, the method comprising:
receiving, from a network node, one or more parameters; and
determining, based on at least the one or more parameters, at least one of:
a first number of Physical Random Access Channel (PRACH) transmissions;
a second number of Physical Uplink Shared Channel (PUSCH) transmissions scheduled by a Random Access Response (RAR) associated with the RA procedure; and
a third number of MsgA PUSCH transmissions.

2. The method of claim 1, further comprising at least one of:
performing the first number of PRACH transmissions;
performing the second number of PUSCH transmissions scheduled by the RAR; and
performing the third number of MsgA PUSCH transmissions.

3. The method of claim 1, wherein the one or more parameters comprise at least one of:
one or more first candidate numbers of PRACH transmissions;
one or more second candidate numbers of PUSCH transmissions scheduled by the RAR associated with the RA procedure;
one or more third candidate numbers of MsgA PUSCH transmissions;
a preamble index; and
an identifier indicating a resource within a Random Access Channel (RACH) indication and partitioning configuration framework.

4. The method of claim 1, wherein when the one or more parameters comprise a single first candidate number, the step of determining the first number comprises:
determining the single first candidate number as the first number.

5. The method of claim 1, wherein when the one or more parameters comprise multiple first candidate numbers, the step of determining the first number comprises:
determining one of the multiple first candidate numbers as the first number based on at least Reference Signal Received Power (RSRP) measured for a selected Synchronous Signal and Physical Broadcast Channel (PBCH) block (SSB).

6-11. (canceled)

12. The method of claim 1, wherein when the RA procedure is a Type 2 RA procedure, the step of determining the first number comprises, after the third number is determined:
determining, from the one or more first candidate numbers, a first candidate number that is associated with the determined third number as the first number.

13. (canceled)

14. The method of claim 12, wherein the one or more first candidate numbers are ordered in an increasing order by their values and are indexed,
wherein the one or more third candidate numbers are ordered in an increasing order by their values and are indexed,
wherein a first candidate number is associated with a third candidate number when their indices are equal to each other.

15. (canceled)

16. The method of claim 1, wherein when the one or more parameters comprise the preamble index, the step of determining the first number comprises:
determining a number associated with a preamble as the first number,
wherein the preamble is indicated by the preamble index and is to be transmitted in a RACH occasion (RO) associated with a selected SSB.

17. The method of claim 16, wherein the one or more parameters further comprise a mapping between the preamble index and the number associated with the preamble.

18. The method of claim 16, wherein the preamble index is an index relative to the first preamble associated with the selected SSB in the RO.

19. The method of claim 1, wherein when the one or more parameters comprise the identifier, the step of determining the first number comprises:
determining a number associated with a resource as the first number,
wherein the resource is indicated by the identifier and is used for at least one of the first number of PRACH transmissions.

20. The method of claim 1, wherein the one or more parameters comprise at least one of:
one or more first parameters for a Type 1 RA procedure; and
one or more second parameters for a Type 2 RA procedure; and
one or more third parameters for both a Type 1 RA procedure and a Type 2 RA procedure.

21. The method of claim 20, wherein the step of determining at least one of the first number and the second number comprises at least one of:
determining at least one of the first number and the second number based on at least the one or more first parameters when the RA procedure is a Type 1 RA procedure;
determining at least one of the first number, the second number, and the third number based on at least the one or more second parameters when the RA procedure is a Type 2 RA procedure; and
determining at least one of the first number, the second number, and the third number based on at least the one or more third parameters no matter whether the RA procedure is a Type 1 RA procedure or a Type 2 RA procedure.

22. (canceled)

23. The method of claim 1, wherein at least one of the one or more parameters is provided in at least one of:
a CFRA configuration;
a Physical Downlink Control Channel order; and
a Beam Failure Recovery configuration.

24. (canceled)

25. The method of claim 1, wherein the RA procedure is a CFRA procedure or a CBRA procedure.

26. The method of claim 1, wherein when the UE supports multiple PRACH transmissions for Type-1 CFRA and/or Type-1 CBRA, the UE also supports repetition of PUSCH scheduled by RAR; or wherein when the UE supports multiple PRACH transmissions for Type-2 CFRA and/or Type-2 CBRA, the UE also supports repetition of MsgA PUSCH.

27. (canceled)

28. The method of claim 1, further comprising:
receiving, from the network node, a RAR;
determining how to interpret the received RAR based on at least whether one or more conditions are met or not.

29-30. (canceled)

31. The method of claim 28, wherein when the RA procedure is a CFRA procedure, the one or more conditions comprise at least one of:
CFRA resources for multiple PRACH transmissions with only K>1 are configured;
CFRA resources for multiple PRACH transmissions with K≥1 are configured, regardless of single or multiple PRACH transmissions of the CFRA resources; and
CFRA resources for multiple PRACH transmissions with K≥1 are configured and the UE initiates multiple PRACH transmissions with K>1 using CFRA resources,
where K is any of the one or more first candidate numbers.

32. The method of claim 1, wherein when the RA procedure is a CFRA procedure and when the CFRA procedure is triggered by a PDCCH order, the method further comprises:
receiving, from the network node, a RAR;
determining how to interpret the received RAR based on at least the PDCCH order.

33-37. (canceled)

38. A User Equipment (UE), comprising:
a processor;
a memory storing instructions which, when executed by the processor, cause the processor to perform operations comprising:
receiving, from a network node, one or more parameters; and
determining, based on at least the one or more parameters, at least one of:
a first number of Physical Random Access Channel (PRACH) transmissions;
a second number of Physical Uplink Shared Channel (PUSCH) transmissions scheduled by a Random Access Response associated with the RA procedure; and
a third number of MsgA PUSCH transmissions.

39-61. (canceled)
